(19) United States
(12) Patent Application Publication
(10) Pub. No.: US 2014/0147088 A1
(43) Pub. Date: May 29, 2014

(54) TRANSMISSION DEVICE, RECEIVING/PLAYING DEVICE, TRANSMISSION METHOD, AND RECEIVING/PLAYING METHOD

(71) Applicants: Toru Kawaguchi, Tokyo (JP); Hiroshi Yahata, Osaka (JP); Tomoki Ogawa, Osaka (JP)

(72) Inventors: Toru Kawaguchi, Tokyo (JP); Hiroshi Yahata, Osaka (JP); Tomoki Ogawa, Osaka (JP)

(73) Assignee: Panasonic Corporation, Osaka (JP)

(21) Appl. No.: 14/233,515

(22) PCT Filed: Jul. 20, 2012
(86) PCT No.: PCT/JP2012/004616

§ 371 Date: Jan. 17, 2014

Related U.S. Application Data
(60) Provisional application No. 61/510,145, filed on Jul. 21, 2011.

(51) Int. Cl. H04N 9/87

(52) U.S. Cl. CPC H04N 9/87
USPC 386/201

(57) ABSTRACT

A transmission device including: a holder holding stream identification information associated with a first transmission stream among a plurality of transmission streams containing a plurality of types of information that are to be played back simultaneously by a receiving playback device, the stream identification information identifying, among the plurality of transmission streams, at least one transmission stream that is different from the first transmission stream; and a transmitter configured to transmit the stream identification information. The receiving side uses the stream identification information to identify at least one transmission stream that is to be played back simultaneously with the first transmission stream.

### TECHNICAL FIELD

The present invention relates to a technology for transmitting and receiving information to be displayed together with the program video.

### BACKGROUND ART

In conventional broadcast services, one or more types of information (video, data, etc.), which are used for the data broadcast, caption service, 3D video or the like, are transmitted in a single transport stream. For example, Patent Literature 1 discloses a technology for transmitting, in one transport stream, a 2D video stream and additional data for 3D video, such as video of a different viewpoint, parallax information, and depth information.

Meanwhile, it is demanded by viewers that various types of information, such as audio and captions not only in Japanese but also in other languages like English, and video not only taken at one viewpoint but also taken at different viewpoints such as in 3D video, and the like, be transmitted and played back.

### CITATION LIST

### Patent Literature

### Patent Literature 1

Tokuhyo (published Japanese translation of PCT international publication for patent application) No. 2008-500790

### SUMMARY OF INVENTION

### Technical Problem

However, in broadcasting, there is a restriction on the radio wave band for transmitting one transport stream, and all of the above-mentioned various types of information may not be transmitted in one transport stream depending on the data amount of the various types of information.

It is therefore an object of the present invention to provide a transmission device, a receiving playback device, a transmission method and a receiving playback method that can transmit or receive and play back various types of information to be played back simultaneously.

### Solution to Problem

The above-described object is fulfilled by a transmission device comprising: a holder holding stream identification information associated with a first transmission stream among a plurality of transmission streams containing a plurality of types of information that are to be played back simultaneously by a receiving playback device, the stream identification information identifying, among the plurality of transmission streams, at least one transmission stream that is different from the first transmission stream; and a transmitter configured to transmit the stream identification information.

### Advantageous Effects of Invention

With the above-described structure, the transmission device transmits the stream identification information. Accordingly, even when various types of information are transmitted in a plurality of transmission streams, the receiving side can identify a transmission stream that is to be played back simultaneously with the first transmission stream, by using the stream identification information.

### BRIEF DESCRIPTION OF DRAWINGS

FIG. 1 is a diagram illustrating the structure of the program distribution system 10.

FIG. 2 is a block diagram illustrating the structure of the transmission device 100.

FIG. 3 is a diagram illustrating one example of the data structure of the PMT.

FIG. 4 illustrates one example of the structure of “external_ES_link_descriptor( )”.

FIG. 5 illustrates one example of the data structure of “view_selection_information( )”.

FIG. 6 illustrates one example of the data structure of “object_information( )”.

FIG. 7 is a block diagram illustrating the structure of the transmission device 200.

FIG. 8 illustrates one example of the data structure of “service_subset_ES_descriptor( )”, continued to FIG. 9.

FIG. 9 illustrates one example of the data structure of “service_subset_ES_descriptor( )”, continued from FIG. 8, continued to FIG. 10.

FIG. 10 illustrates one example of the data structure of “service_subset_ES_descriptor( )”, continued from FIG. 9, continued to FIG. 11.

FIG. 11 illustrates one example of the data structure of “service_subset_ES_descriptor( )”, continued from FIG. 10.

FIG. 12 is a block diagram illustrating the structure of the digital TV (receiving playback device) 300.

FIG. 13 is a flowchart illustrating the operation of the transmission device 100.

FIG. 14 is a flowchart illustrating the operation of the receiving playback device 300.

FIG. 15 is a block diagram illustrating the structure of the transmission device 1100.

FIG. 16 illustrates one example of the data structure of “external_ES_link_info”.

FIG. 17 illustrates a description example of “external_ES_link_info”.

FIG. 18 is a block diagram illustrating the structure of the transmission device 1200.

FIG. 19 illustrates one example of the data structure of “subset_service_ES_info”.

FIG. 20 illustrates a description example of “subset_service_ES_info”.

FIG. 21 is a block diagram illustrating the structure of the receiving playback device 1300.

FIG. 22 is a flowchart illustrating an outline of the operation of the program distribution system in Embodiment 2.

FIG. 23 is a flowchart illustrating the operation of the receiving playback device 1300.

FIG. 24 illustrates one example of the data structure of “hyperlink_descriptor( )”.

FIG. 25 illustrates one example of the data structure of “link_external_component_info( )”.

FIG. 26A illustrates a list of extended attributes described to specify a sub stream for the element “object” indicating the main stream; and FIG. 26B illustrates a description example of a data broadcast content in which the attributes are used to specify a sub stream.

FIG. 27 is a diagram illustrating one example of the structure defining element “ExternalES”, continued to FIG. 28.

FIG. 28 is a diagram illustrating one example of the structure defining element “ExternalES”, continued from FIG. 27.

FIG. 29 illustrates a description example of ERI for specifying a sub stream by using element “ExternalEs”.

### DESCRIPTION OF EMBODIMENTS

### 1. Outline

As described above, it is expected that various types of information be broadcast in the broadcast service in future, but there is a restriction on the radio wave band for transmitting transport streams, and all of the above-mentioned various types of information may not be transmitted in one transport stream depending on the data amount of the various types of information.

One option for solving this problem will be to use a plurality of transport streams to transmit the program and the various types of information.

However, at present, there is no mechanism for identifying, among innumerable broadcast waves and a plurality of transport streams, a stream including a service (for example, a caption in a language other than the regular language) for one program so that the viewer can select a desired piece of information.

As a result of intensive studies for a solution of the problem, the inventors reached the present invention in which various types of information are transmitted by using a plurality of transport streams and received and played back.

According to one aspect of the present invention, there is provided a transmission device comprising: a holder holding stream identification information associated with a first transmission stream among a plurality of transmission streams containing a plurality of types of information that are to be played back simultaneously by a receiving playback device, the stream identification information identifying, among the plurality of transmission streams, at least one transmission stream that is different from the first transmission stream; and a transmitter configured to transmit the stream identification information.

### 2. Embodiment 1

The following describes an embodiment of the present invention with reference to the attached drawings.

2.1 Outline

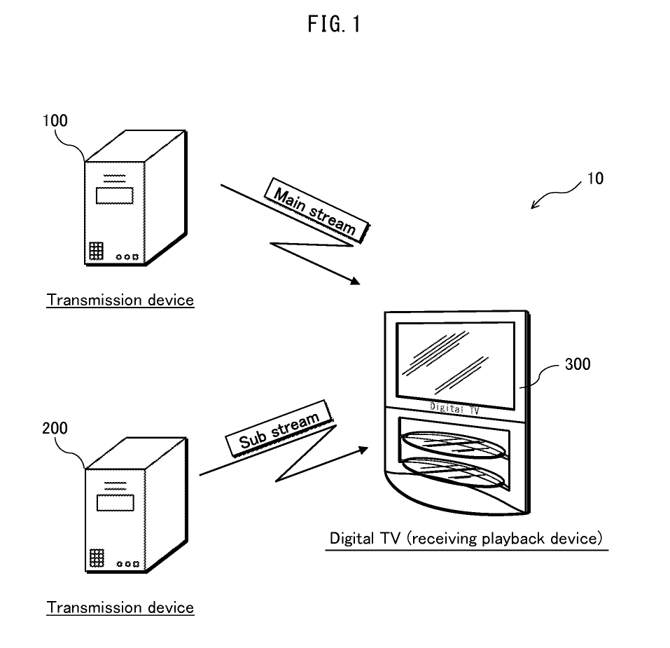

As illustrated in FIG. 1, a program distribution system 10 in the present embodiment includes transmission devices 100 and 200, and a digital TV (receiving playback device) 300.

In the digital TV broadcast, transport streams (TS) in which video and audio streams and program arrangement information are multiplexed in conformance with the MPEG system standard are transmitted over broadcast signals from the transmission devices 100 and 200. Here, the program arrangement information refers to SI/PSI (Service Information/Program Specific Information) in which detailed information concerning the TS transmission such as network information, broadcasting station and channel (service), and event detailed information and the like are described.

The transmission devices 100 and 200 transmit transport streams (TS) in which video and audio streams and the like are multiplexed.

In the present embodiment, each TS transmitted by the transmission devices 100 and 200 is a transport stream conforming to the MPEG2-TS (Moving Picture Experts Group 2-Transport Stream) as implemented in conventional 2D digital broadcasting. The transport stream conforming to the MPEG2-TS contains one or more video and audio streams and PSI describing to what programs the video and audio streams belong. The PSI includes PAT (Program Association Table), PMT (Program Map Table) and the like, wherein the PAT indicates a list of programs contained in the TS, and the PMT stores a PID (Packet ID) of a video stream, an audio stream or the like that belongs to a program.

Furthermore, the transport stream conforming to the MPEG2-TS contains SI that describes network information, organization channel information, and event information.

The SI includes tables such as NIT (Network Information Table), SDT (Service Description Table), and EIT (Event Information Table).

In the NIT, information concerning the network via which the transmitted TS is transferred (channel number, modulation method, etc.) is described.

In the SDT, information concerning the service contained in the transmitted TS (service name, type of service, digital copy control information, etc.) is described.

In the EIT, detailed information concerning the events included in each service (event name, broadcast date and time, contents of the event, etc.) is described.

The digital TV (receiving playback device) 300 can create an Electronic Program Guide (EPG) by using the information described in the SI.

Each TS transmitted from the transmission devices 100 and 200 contains information that is to be played back simultaneously in one program. For example, a TS transmitted from the transmission device 100 contains video for the left eye and audio in a 3D program, and a TS transmitted from the transmission device 200 contains video for the right eye in the 3D program. In that case, the TS transmitted from the transmission device 100 can be played back independently, and the TS transmitted from the transmission device 200 cannot be played back independently.

In the following, the left-eye video stream contained in the TS transmitted from the transmission device 100 is referred to as a “main stream”, and the right-eye video stream contained in the TS transmitted from the transmission device 200 is referred to as a “sub stream”.

The receiving playback device 300, when it receives the TS containing the main stream over the broadcast waves transmitted from the transmission device 100 before it receives the TS containing the sub stream transmitted from the transmission device 200, separates the video and audio streams and the SI containing the program arrangement information and the like from the received TS. The receiving playback device 300 judges, based on the separated various information of the SI/PSI such as the SI, whether or not there is a sub stream corresponding to the main stream, and when it judges that there is the sub stream, it receives the TS containing the sub stream and plays back the main and sub streams simultaneously. More specifically, the receiving playback device 300 generates the left-eye video and the right-eye video from the main stream and the sub stream, respectively, and performs a 3D playback.

The receiving playback device 300, when it receives the TS containing the sub stream over the broadcast waves transmitted from the transmission device 200 before it receives the TS containing the main stream transmitted from the transmission device 100, judges whether playing back only the sub stream is possible, and depending on the result of the judgment, plays back only the sub stream or plays back the main stream and the sub stream simultaneously.

2.2 Structure of Transmission Device 100

The transmission device 100 generates a TS containing the main stream for a program, and distributes the TS.

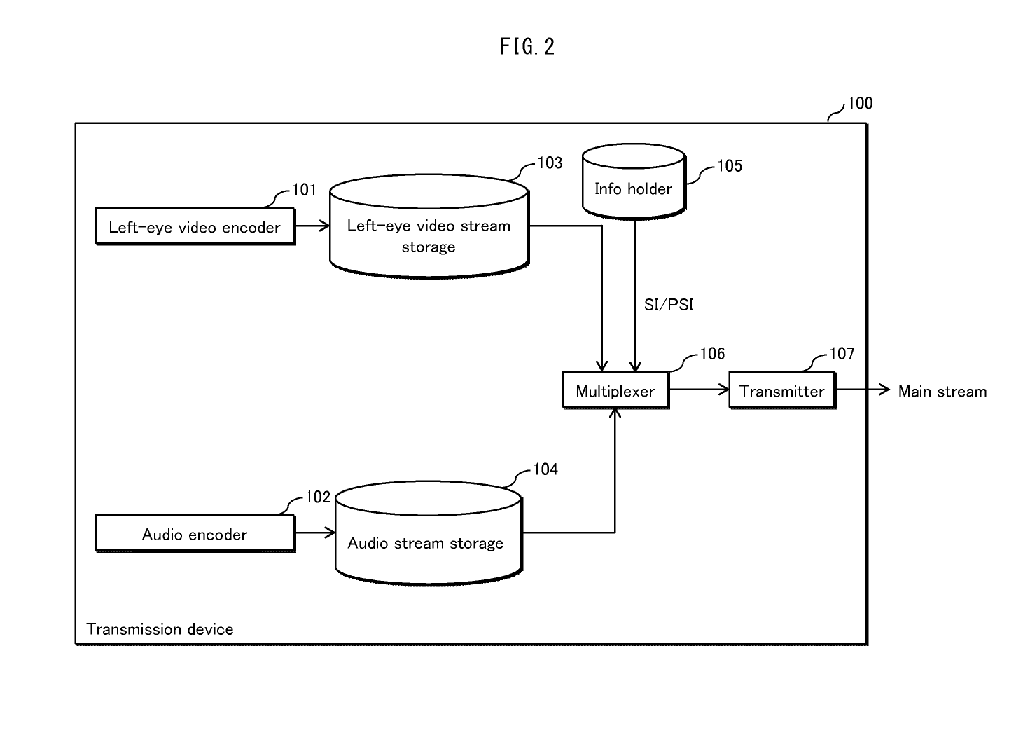

As illustrated in FIG. 2, the transmission device 100 includes a left-eye video encoder 101, an audio encoder 102, a left-eye video stream storage 103, an audio stream storage 104, an information holder 105, a multiplexer 106, and a transmitter 107.

(1) Left-Eye Video Encoder 101

The left-eye video encoder 101 generates the left-eye video stream (namely, the main stream) by encoding the left-eye video (pictures), which is played back when a 3D display of a program is performed, by an encoding method such as MPEG-2 or MPEG-4, and writes the generated left-eye video stream onto the left-eye video stream storage 103.

(2) Audio Encoder 102

The audio encoder 102 generates the audio stream by compress-encoding the audio data by the linear PCM method or the like, and writes the generated audio stream onto the audio stream storage 104.

(3) Left-Eye Video Stream Storage 103

The left-eye video stream storage 103 is a storage for storing the left-eye video stream generated by the left-eye video encoder 101.

(4) Audio Stream Storage 104

The audio stream storage 104 is a storage for storing the audio stream generated by the audio encoder 102.

(5) Information Holder 105

The information holder 105 is a storage for storing the SI/PSI that is transmitted with the main stream. Note that the SI/PSI may be created by an external device, or may be created by the transmission device 100.

The following describes the PMT contained in the SI/PSI.

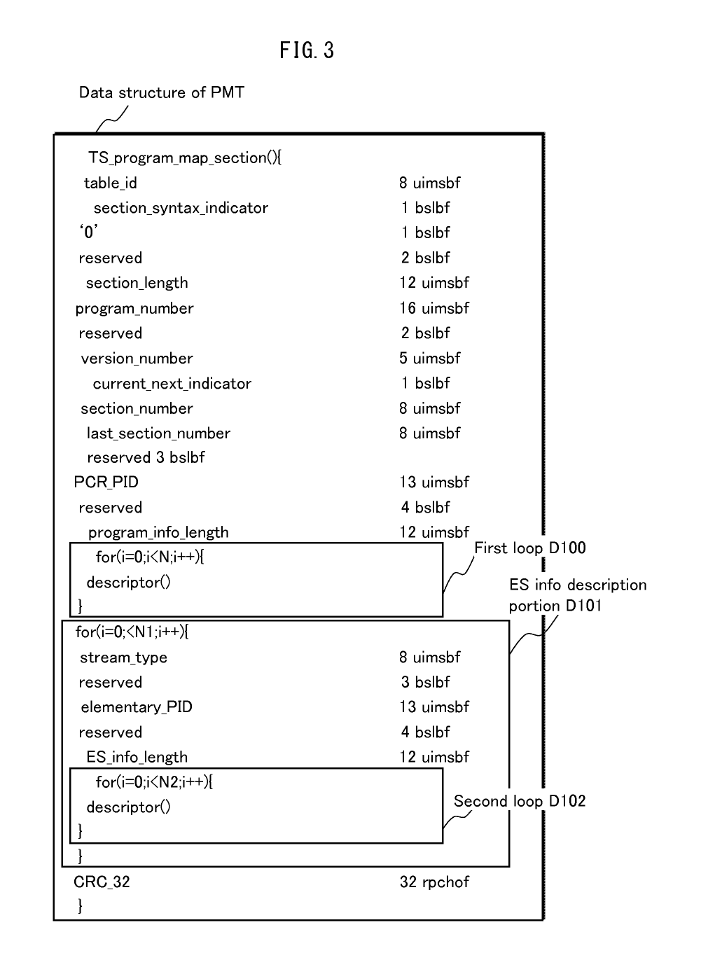

FIG. 3 is a diagram illustrating the data structure of the PMT. The meaning of each parameter is defined in the ISO/IEC13818-1 (MPEG-2), and description thereof is omitted. In the PMT, there are two places where a descriptor can be placed.

One of the places is a portion called “first loop D100”. A descriptor can be placed in “descriptor( )” in the first loop D100. A plurality of descriptors can be inserted into the portion “descriptor( )”. Descriptors pertaining to the entire program are placed in this portion.

The other of the places is a portion called “second loop D102”, which is included in “ES information description portion D101”. The ES information description portion D101 starts immediately after the first loop D100, with a “for” statement that is repeated as many times as the number of ESs contained in the program. Parameters, such as “stream_type” and “elementary PID”, included in this “for” statement are parameters pertaining to that ES. The second loop D102 is included in the ES information description portion D101. A descriptor can be placed in “descriptor( )” in the second loop D102. A plurality of descriptors can be inserted into the portion “descriptor( )”. Descriptors pertaining to that ES are placed in this portion.

In the present embodiment, “external_ES_link_descriptor( )”, which describes the reference information of the sub stream, is defined and placed in the second loop D102.

Note that the description content of the “external_ES_link_descriptor( )” is explained below.

(6) Multiplexer 106

The multiplexer 106 generates a TS in the MPEG2-TS format by multiplexing the left-eye video stream, which is stored in the left-eye video stream storage 103, the audio stream, which is stored in the audio stream storage 104, the SI/PSI, which is stored in the information holder 105, and the like, and transmits the generated TS via the transmitter 107.

Note that, not limited to the structure where the video and audio are compress-encoded and stored in advance, uncompressed video and audio may be encoded and multiplexed simultaneously in real time.

(7) Transmitter 107

The transmitter 107 transmits the TS in the MPEG2-TS format generated by the multiplexer 106.

2.3 Regarding “external_ES_link_descriptor( )”

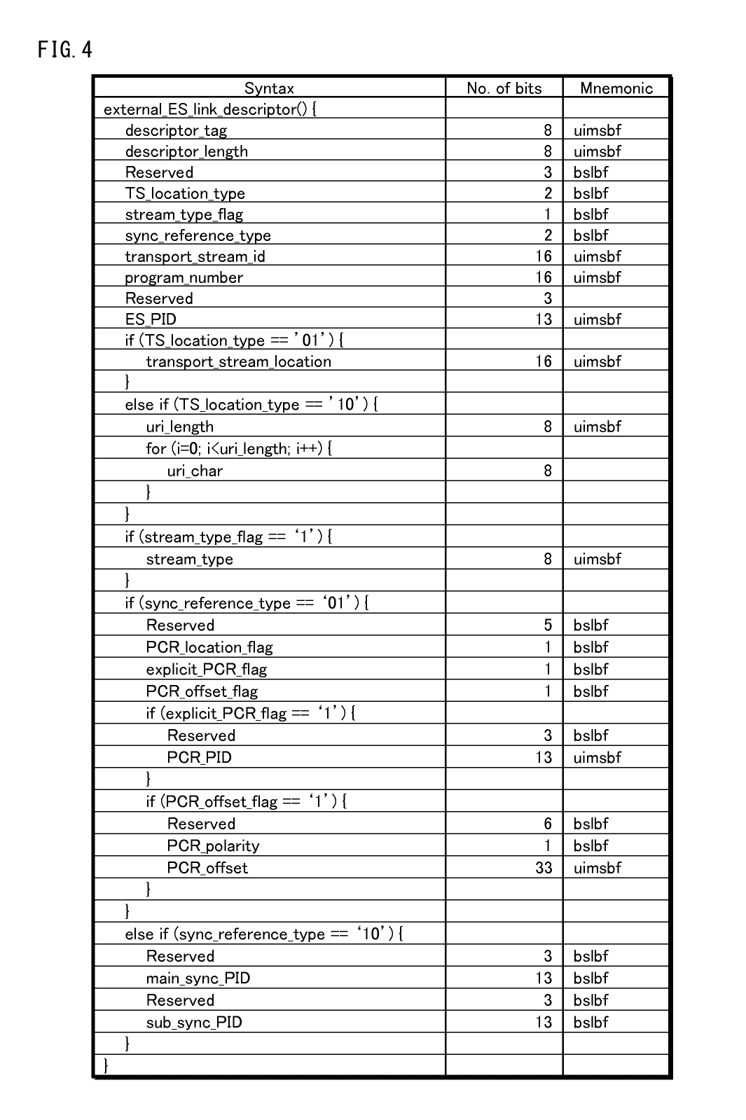

The following explains a specific description content of the “external_ES_link_descriptor( )”. FIG. 4 illustrates one example of the structure of “external_ES_link_descriptor( )”.

The following explains description elements of the “external_ES_link_descriptor( )”.

A description element “descriptor_tag” includes a unique value identifying that descriptor and distinguishing it from other descriptors.

A description element “descriptor_length” indicates the number of bytes assigned to the fields of that descriptor, which range from the next field to the last field.

A description element “Reserved” is an area reserved for future extension, and a binary digit “1” is written therein as many times as the number of bits assigned thereto.

A description element “TS_location_type” indicates the type of the network via which the sub stream is transferred. More specifically, a value “00” indicates that the sub stream is transferred via the same broadcast network as the main stream. A value “01” indicates that the sub stream is transferred via a broadcast network that is different from a broadcast network via which the main stream is transferred, wherein the broadcast network of the sub stream is indicated by a description element “transport_stream_location” located after this. A value “10” indicates that the sub stream can be accessed by a medium other than the broadcasting, via a URI indicated by a description element “uri_char” located after this. By referencing this value, the digital TV 300 having received the main ST can recognize how to access the sub stream.

A description element “stream_type_flag” is a flag indicating whether or not a description element “stream_type” located after this contains description.

A description element “sync_reference_type” indicates whether or not there is means for synchronizing the main stream and the sub stream, and indicates the method therefor. A value “00” indicates that the receiving device does not synchronize the main stream and the sub stream, and that decoding and displaying the main stream are performed in accordance with the PCR (Program_Clock_Reference) included in the main stream, and decoding and displaying the sub stream are performed in accordance with the PCR included in the sub stream. A value “01” indicates that the synchronization is performed by using the PCR by referencing the PCR reference information that starts with “PCR_location_flag” located after this. A value “10” indicates that the synchronization is performed by using an independent synchronization track by referencing the sync track reference information that starts with “main_sync_PID” located after this. By referencing this value, the digital TV 300 can recognize whether or not there is a means for synchronizing the main stream and the sub stream, and recognize the method therefor.

A description element “transport_stream_id” indicates the ID of a transport stream by which the referenced sub stream is transferred.

A description element “program_number” indicates the program number of a program that includes the referenced sub stream.

A description element “ES_PID” indicates the PID of the referenced sub stream.

By describing the above-mentioned “transport_stream_id”, “program_number”, and “ES_PID”, it is possible to identify the ES of the sub stream that can be used at the same time when an ES corresponding to the second loop D102 of the PMT in which the descriptor itself is placed is used. Note that, when there is no such sub stream, the “program_number” is written as “0x00” indicating that there is no such sub stream.

A description element “transport_stream_location”, in the case where the referenced sub stream is transferred via another broadcast network (for example, a satellite broadcast distinguished from the terrestrial broadcast), indicates the network via which the sub stream is transferred. For example, the network ID (for example, 0x40f1) of the network via which the sub stream is transferred is described in the “transport_stream_location”. With this structure, even in the case where the sub stream is transferred via a broadcast network different from the network via which the main stream is transferred, the digital TV 300 can recognize the transfer position.

A description element “uri_length” indicates the number of bytes assigned to “uri_char” located after this.

In “uri_char”, a URI is described, wherein the URI can be used to access the referenced sub stream when the sub stream can be accessed via a medium other than the broadcasting. A description example of the URI is explained below.

A description element “stream_type” indicates, in a format defined in “ISO/IEC 13818-1”, the stream type of the sub stream. For example, when the sub stream conforms to H.264AVC, the “stream_type” is written as “0x1B”. With this structure, the digital TV 300 can recognize, before accessing the sub stream, whether or not the sub stream can be used. Furthermore, the “stream_type” may be used to specify the use of the sub stream. A specific example of the “stream_type” is explained below.

A description element “PCR_location_flag” indicates which of PCR (Program Clock Reference) of the main stream and PCR of the sub stream is to be referenced when the main stream and the sub stream are decoded and displayed in synchronization in accordance with a common PCR. When the “PCR_location_flag” is set to “0”, it indicates that PCR of the main stream is to be used. When the “PCR_location_flag” is set to “1”, it indicates that PCR of the sub stream is to be used. With this structure, it is possible to specify which of PCR of the main stream and PCR of the sub stream is to be referenced, depending on the reliability of the transfer path or the like. Furthermore, this allows for the digital TV to recognize which of PCR of the main stream and PCR of the sub stream to reference when it synchronizes the main stream and the sub stream by using the PCR.

A description element “explicit_PCR_flag” indicates whether or not “PCR_PID” is described in the descriptor itself. When the “explicit_PCR_flag” is set to “0”, it indicates that “PCR_PID” is not described in the descriptor, but PCR described in “PCR_PID” in PMT of the main stream or the sub stream is used. When the “explicit_PCR_flag” is set to “1”, it indicates that PCR described in “PCR_PID” after this flag is used. This makes it possible to specify which of an existing PCR or a PCR unique to a synchronous playback of the main stream and the sub stream is to be used.

A description element “PCR_offset_flag” indicates whether or not an offset is specified when a synchronous playback of the main stream and the sub stream is performed by using a specified PCR. When the “PCR_offset_flag” is set to “0”, it indicates that an offset value is not specified. When the “PCR_offset_flag” is set to “1”, it indicates that an offset value is specified.

A description element “PCR_PID” specifies PID of PCR that is included in the main stream or the sub stream and is to be referenced during the synchronous playback of the main stream and the sub stream. With this structure, when the receiving device uses a PCR unique to the synchronous playback when it performs the synchronous playback, the receiving device can recognize the PID of the PCR.

A description element “PCR_polarity” indicates the polarity of the offset value. When the “PCR_polarity” is set to “0”, it indicates that a value is obtained by adding the value of “PCR_offset” following this element to the value of the PCR included in the stream specified by “PCR_location”, and the obtained value is used when the stream that is not specified by “PCR_location” is decoded and displayed. When the “PCR_polarity” is set to “1”, it indicates that a value is obtained by subtracting the value of “PCR_offset” following this element from the value of the PCR included in the stream specified by “PCR_location”, and the obtained value is used when the stream that is not specified by “PCR_location” is decoded and displayed.

A description element “PCR_offset” indicates the absolute value of the offset value. For example, when the “PCR_location_flag” is set to “0”, and the PCR included in the main stream is used, a value, which is obtained by offsetting the PCR included in the main stream in accordance with “PCR_polarity” and “PCR_offset”, is used when the sub stream is decoded and displayed. Also, when the “PCR_location_flag” is set to “1” and the PCR included in the sub stream is used, a value, which is obtained by offsetting the PCR included in the sub stream in accordance with “PCR_polarity” and “PCR_offset”, is used when the main stream is decoded and displayed. In this way, by specifying “PCR_polarity” and “PCR_offset”, it is possible to realize a synchronous playback even when the main stream and the sub stream do not have the same start value of the PCRs to be referenced.

A description element “main_sync_PID” indicates the PID of the synchronization track of the main stream.

A description element “sub_sync_PID” indicates the PID of the synchronization track of the sub stream.

By using the “main_sync_PID” and “sub_sync_PID”, it is possible to synchronize the main stream and the sub stream regardless of the values of the PCRs. Note that the synchronization track may describe the relationship between the time stamps of the main and sub streams and a time code that is common to the main and sub streams by using the “synchronized auxiliary data” defined in ETSI TS 102 823 (Specification for the carriage of synchronized auxiliary data in DVB transport streams), for example.

Up to now, a new descriptor “external_ES_link_descriptor( )” has been explained. This descriptor is used to specify a sub stream that can be used together when a main stream is played back as a video and audio service, enabling the main and sub streams to be played back simultaneously (played back in synchronization).

(Description Examples of URI)

The following explains URI examples that may be described in the new descriptor “external_ES_link_descriptor( )”.

When it is described as “http://aaa.sample.com/bbb.ts”, it indicates that the http protocol is used to access a file “bbb.ts” provided in a site “aaa.sample.com”. Note that the file “bbb.ts” is the substance of the TS file storing the sub stream.

When it is described as “http://aaa.sample.com/ccc.cpc”, it indicates that the http protocol is used to access a file “ccc.cpc” provided in a site “aaa.sample.com” via a communication. Note that the file “ccc.cpc” is a playback control metafile that is used to access the TS file storing the sub stream.

When it is described as “rtsp://aaa.sample.com/ddd.ts”, it indicates that the http protocol is used to access a file “ddd.ts” provided in the site “aaa.sample.com” via a communication. Note that the file “ddd.ts” is the substance of the TS file storing the sub stream.

When it is described as “arib-file://DirA/DirB/eee.ts”, it indicates to access a file “fff.ts” in a folder “DirA/DirB” that has been stored in a local storage medium in advance. Note that the file “fff.ts” is the substance of the TS file storing the sub stream.

When it is described as “crid://aaa.sample.com/zzz”, it indicates to access a video having a CRID (Content Reference Identifier) that is indicated by “aaa.sample.com/zzz”. The receiving-side device uses the CRID to solve the location problem by the description method defined in “ETSI TS 102 822 Part4” or “ARIB STD-B38 4.1.3”.

(Specific Examples of stream_type)

The following explains values that may be written in “stream_type” in the new descriptor “external_ES_link_descriptor( )”. Note that the following values may be described in a newly-provided field other than “stream_type”.

In the present embodiment, any of the values from “0x80” to “0x8A” is assigned to the “stream_type”. The following describes each of these values.

When the “stream_type” has a value “0x80”, it indicates that the sub stream represents one of the two views that is different from the view represented by the main stream (for example, the right-eye view as opposed to the left-eye view) in the two-eye type stereoscopic video. Note that in the program distribution system 10 in the present embodiment, the “stream_type” is set to “0x80”.

When the “stream_type” has a value “0x81”, it indicates that the sub stream is a difference between the view indicated by the value “0x80” and the view of the main stream.

When the “stream_type” has a value “0x82”, it indicates that the sub stream is a difference component for increasing the resolution of video of the main stream in the one dimensional direction (for example, for increasing from 960×1080 pixels per eye in the two-eye type stereoscopic video of the side-by-side method to 1920×1080 pixels per eye).

When the “stream_type” has a value “0x83”, it indicates that the sub stream is a difference component for increasing the resolution of video of the main stream in the two dimensional direction (for example, for increasing the resolution of an image from 1920×1080 pixels to 3840×2160 pixels).

When the “stream_type” has a value “0x84”, it indicates that the sub stream is a difference component for adding the color depth information to the video of the main stream (for example, for extending each piece of 8-bit information representing each of colors red, green and blue to 12-bit information).

When the “stream_type” has a value “0x85”, it indicates that the sub stream is a depth map that is used when a stereoscopic video is generated from the main stream.

When the “stream_type” has a value “0x86”, it indicates that the sub stream is occlusion information that is used when a stereoscopic video is generated from the main stream.

When the “stream_type” has a value “0x87”, it indicates that the sub stream is transparency information that is used when a stereoscopic video is generated from the main stream.

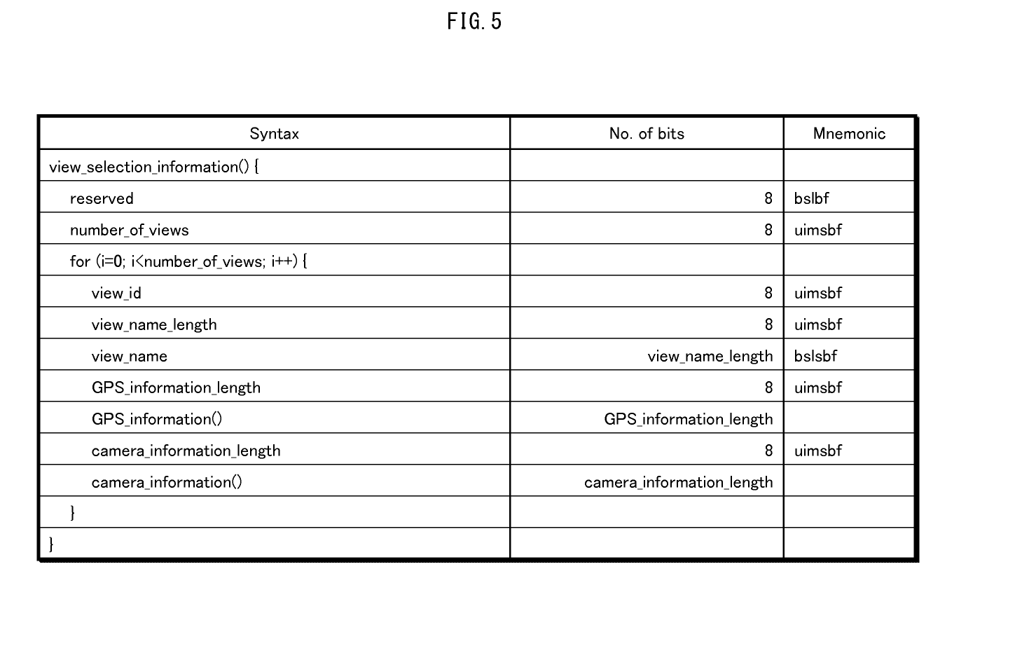

When the “stream_type” has a value “0x88”, it indicates that the sub stream represents video of a viewpoint (for example, the non-base view defined in MPEG-4 MVC) that is different from a viewpoint of the video of the main stream. In that case, when there are a plurality of videos of different viewpoints, it is useful to describe, for each viewpoint, a camera name, position information (GPS), and optical parameters such as the camera direction and zoom level since it will facilitate the user to select a viewpoint. The information such as the camera name may be described in the form of a new descriptor or a private stream in the system stream storing the video of the main and sub streams, or may be described in the video of the main and sub streams as the metadata in the user extension area, or may be transferred on a path (for example, in the HTML5 format linked with the main and sub streams) different from a path on which the main and sub streams are transferred. FIG. 5 illustrates one example of the data structure of the descriptor format (view_selection_information( )). In the descriptor illustrated in FIG. 5, a description element “number_of_views” indicates the number of different viewpoints. Each of the following elements is defined as many times as the number of different viewpoints. A description element “view_id” identifies a corresponding viewpoint. A description element “view_name_length” indicates the number of bytes assigned to “view_name” that is described immediately after this description element. In “view_name”, the camera name is described. A description element “GPS_information_length” indicates the number of bytes assigned to “GPS_information( )” that is described immediately after this description element. In “GPS_information( )”, the GPS information is described. A description element “camera_information_length” indicates the number of bytes assigned to “camera_information( )” that is described immediately after this description element. In “camera_information( )”, optical parameters such as the camera direction and zoom level are described.

For example, in the baseball game program, images are captured by cameras placed at various viewpoints, such as the first base bench and the third base bench. In that case, when the user wants to see the entire infield from the first base bench, the user may specify, for example, a camera named “first base” among a plurality of viewpoints. Furthermore, by combining the position information, cameral direction and zoom information, it is possible to graphically display cameras disposed on a sketch of a baseball park so that the user can select a viewpoint among a plurality of viewpoints from which the user wants to view the video, not by specifying the camera name.

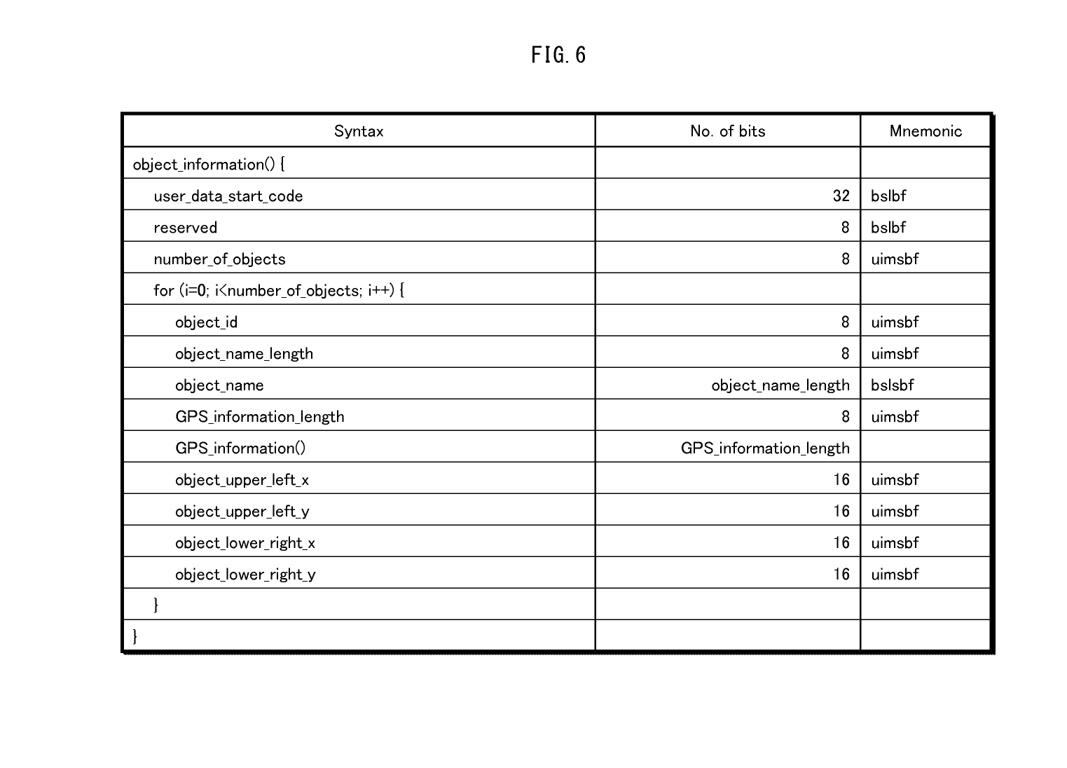

When the “stream_type” has a value “0x89”, it indicates that the sub stream is free-view video information that is used to generate a video of an arbitrary viewpoint. When huge video information, which enables video from an arbitrary viewpoint among a plurality of viewpoints (for example, video of an entire field in the live broadcasting of a soccer game) to be generated, is transferred, a function to extract a specific area depending on the interest or preference of the user and play back or display the extracted area is considered very useful. Accordingly, by encoding and transferring, as metadata, names and positional information (GPS information or positional information in the encoded video) of various objects captured for the huge video information, positional information of cameras, and optical parameter information, it becomes possible for the user to extract a specific area and play back or display it based on the metadata. The information as such may be described in the form of a new descriptor or a private stream in the system stream storing the video of the main and sub streams, or may be described in the video of the main and sub streams as the metadata in the user extension area, or may be transferred on a path (for example, in the HTML5 format linked with the main and sub streams) different from a path on which the main and sub streams are transferred. FIG. 6 illustrates one example of the metadata structure of the user extension area (object_information( )). A description element “number_of_objects” indicates the number of objects that each correspond a name and a piece of position information. In “object_id”, information for identifying an object is described. In “object_name”, the name of the object is described. A description element “GPS_information( )” has description of GPS position information of the image-capture object identified by the “object_id” and “object_name”.

For example, in the live broadcasting of a soccer game, the user may watch it centering on a specific player when the player's name and position information of the player in the video are transferred as the metadata. When video of an arbitrary viewpoint is generated by combining video captured by cameras located at a plurality of viewpoints, the video generation accuracy can be increased if there are GPS information of an interested object and GPS information of the cameras located at the plurality of viewpoints to be combined (positions and directions of the cameras).

When the “stream_type” has a value “0x8A”, it indicates that the sub stream represents video that is overlaid as additional information on the video of the main stream. For example, MPEG-4 MVC may be used to transfer a video in which additional information is overlaid on the video of the main stream. By encoding the main stream as the base view of the MVC and encoding the sub stream as the non-base view of the MVC, the sub stream can transfer efficiently only video information (overlaid additional information) that is different from the video of the main stream. For example, when the main stream represents the video of the live broadcasting of a soccer game, the sub stream may be video (video constituted from differences from the main stream) for overlaying attribute information, such as names and running distances of the players in the main stream video, in the periphery of each player graphically. With this structure, by applying a difference transferred by the sub stream (stream_type=0x8A) to the main stream (namely, by decoding and playing back the non-base view), it is possible to present the user with a live broadcasting of a soccer game on which additional information is overlaid.

Up to now, the values that may be assigned to “stream_type” have been explained. With the above-described structure, the receiving-side device can recognize, before accessing the sub stream, how the sub stream can be used.

In the case where video of a program (video captured at a viewpoint) is transmitted by one transport stream and different information (for example, video captured at a different viewpoint for 3D display) is transmitted by a different transport stream, it is necessary to synchronize the videos in the transport streams. However, no conventional technology provides means for synchronizing the videos. In view of this, as described above, information pertaining to the synchronization such as “sync_reference_type” is included in “external_ES_link_descriptor( )”. This makes it possible to synchronize the respective videos included in the two transport streams.

2.4 Structure of Transmission Device 200

The transmission device 200 transmits a sub stream that correspond to the main stream transmitted by the transmission device 100.

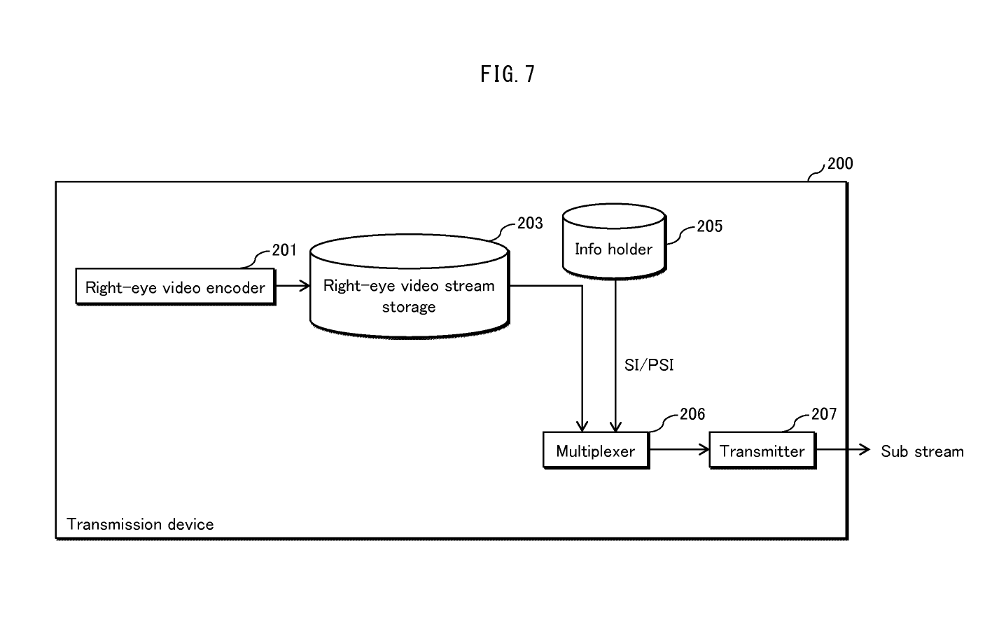

As illustrated in FIG. 7, the transmission device 200 includes a right-eye video encoder 201, a right-eye video stream storage 203, an information holder 205, a multiplexer 206, and a transmitter 207.

(1) Right-Eye Video Encoder 201

The right-eye video encoder 201 generates the right-eye video stream (namely, the sub stream) by encoding the right-eye video (pictures), which corresponds to the left-eye video transmitted from the transmission device 100, by an encoding method such as MPEG-2 or MPEG-4, and writes the generated right-eye video stream onto the right-eye video stream storage 203.

(2) Right-Eye Video Stream Storage 203

The right-eye video stream storage 203 is a storage for storing the right-eye video stream generated by the right-eye video encoder 201.

(3) Information Holder 205

The information holder 205 is a storage for storing the SI/PSI that is to be transmitted together with the sub stream. Note that the SI/PSI may be created by an external device or the transmission device 200.

The SI/PSI stored in the information holder 205 has the same data structure as the SI/PSI stored in the information holder 105. It should be noted here that the device for transmitting the sub stream defines “service_subset_ES_descriptor( )”, in which the reference information of the main stream is described, and places the “service_subset_ES_descriptor( )” in the second loop of the PMT.

Description contents of the “service_subset_ES_descriptor( )” are explained below.

(4) Multiplexer 206

The multiplexer 206 generates a TS in the MPEG2-TS format by multiplexing the right-eye video stream (the sub stream) stored in the right-eye video stream storage 203 and the SI/PSI stored in the information holder 205, and transmits the generated TS via the transmitter 207.

(5) Transmitter 207

The transmitter 207 transmits the TS in the MPEG2-TS format generated by the multiplexer 206.

2.5 Regarding “service_subset_ES_descriptor( )”

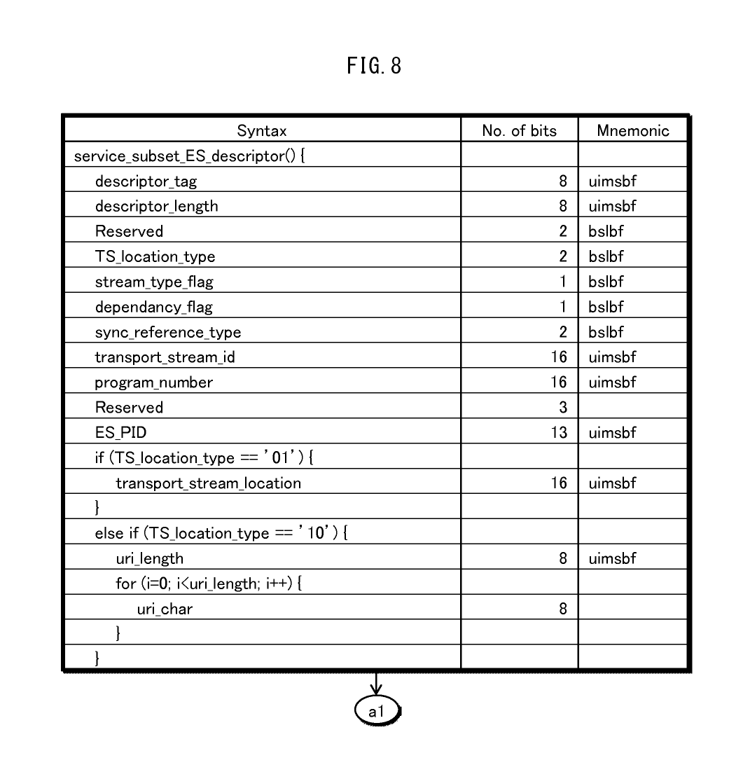

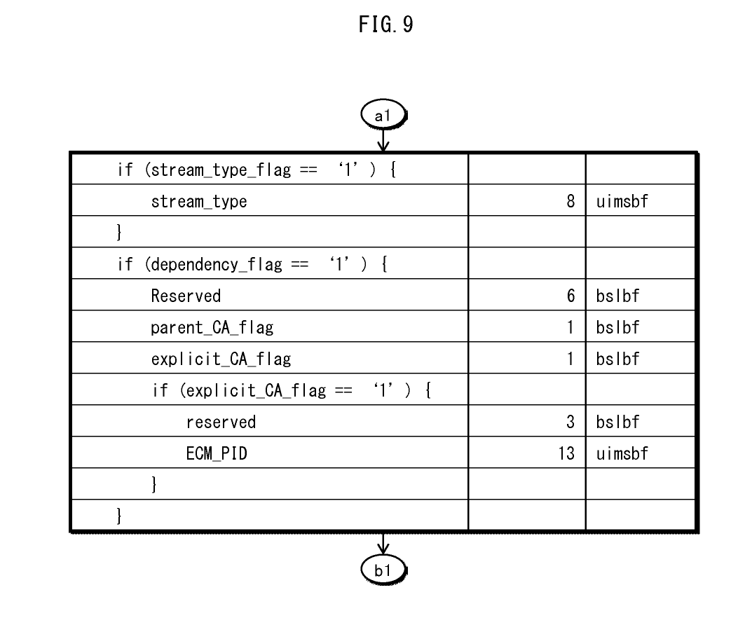

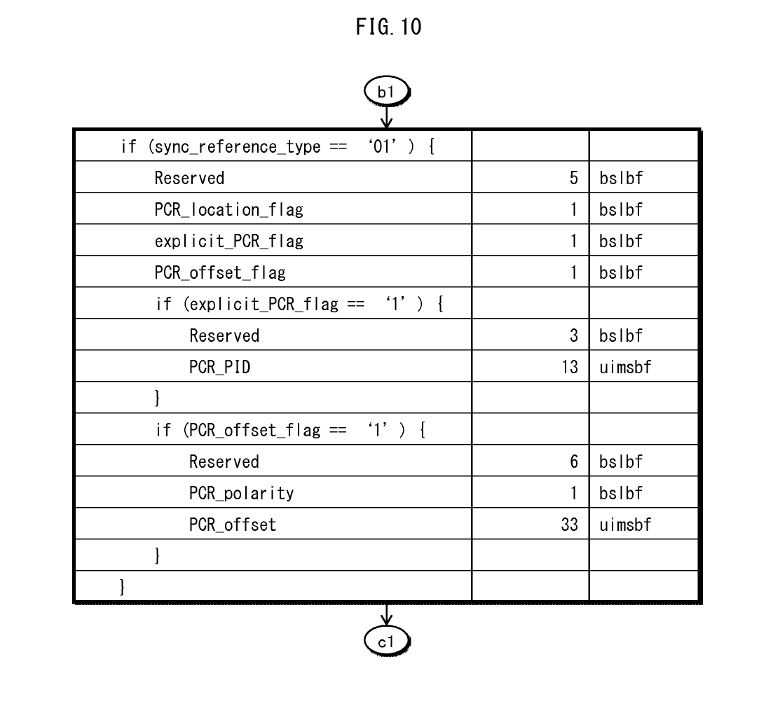

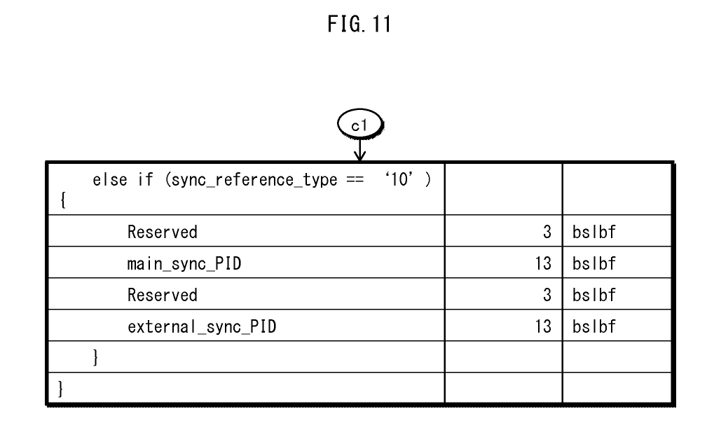

The following explains a specific description content of the “service_subset_ES_descriptor( )”. FIGS. 8 to 11 illustrate one example of the structure of “service_subset_ES_descriptor( )”.

A description element “descriptor_tag” includes a unique value identifying that descriptor and distinguishing it from other descriptors.

A description element “descriptor_length” indicates the number of bytes assigned to the fields of that descriptor ranging from the next field to the last field.

A description element “Reserved” is an area reserved for future extension, and a binary digit “1” is written therein as many times as the number of bits assigned thereto.

A description element “TS_location_type” indicates the type of the network via which the main stream is transferred. More specifically, a value “00” indicates that the main stream is transferred via the same broadcast network as the sub stream. A value “01” indicates that the main stream is transferred via a broadcast network that is different from a broadcast network via which the sub stream is transferred, wherein the broadcast network of the main stream is indicated by a description element “transport_stream_location” located after this. A value “10” indicates that the main stream can be accessed by a medium other than the broadcasting, via a URI indicated by a description element “uri_char” located after this. With this structure, the device having received the sub stream (the digital TV) can recognize how to access the main stream.

A description element “stream_type_flag” is a flag indicating whether or not a description element “stream_type” located after this contains description.

A description element “dependency_flag” indicates whether or not it is possible to play back the sub stream without depending on the main stream. A value “0” indicates that playing back only the sub stream is possible. A value “1” indicates that the sub stream can be played back only when it is used simultaneously with the main stream. With this structure, when the sub stream is received separately from the main stream by the digital TV, it is possible to permit or inhibit the playback of the sub stream in accordance with the intention of the transmitter thereof.

A description element “sync_reference_reference” here is the same as the “sync_reference_reference” illustrated in FIG. 3, and explanation thereof is omitted here.

A description element “transport_stream_id” indicates the ID of a transport stream by which a parent main stream is transferred. A description element “program_number” indicates the program number of a program that includes the parent main stream. A description element “ES_PID” indicates the PID of the parent main stream. By describing the above-mentioned “transport_stream_id”, “program_number”, and “ES_PID”, it is possible to identify the ES of the parent main stream when an ES corresponding to the second loop of the PMT in which the descriptor itself is placed is used. Note that, to specify a parent program, not a specific ES, a null value (0x1FF indicating a null packet) is described in the “ES_PID”.

A description element “transport_stream_location”, in the case where the parent main stream is transferred via another broadcast network (for example, a satellite broadcast distinguished from the terrestrial broadcast), indicates the network via which the main stream is transferred. For example, the network ID (for example, 0x40f1) of the network via which the main stream is transferred is described in the “transport_stream_location”. With this structure, even in the case where the main stream is transferred via a broadcast network different from the network via which the sub stream is transferred, the digital TV can recognize the transfer position.

A description element “uri_length” indicates the number of bytes assigned to “uri_char” located after this.

In “uri_char”, a URI is described, wherein the URI can be used to access the TS containing the parent main stream when the parent main stream can be accessed via a medium other than the broadcasting. A description example of the URI is the same as the description example explained above, and detailed explanation using the description example is omitted here.

A description element “stream_type” indicates, in a format defined in “ISO/IEC 13818-1”, the stream type of the main stream. For example, when the main stream conforms to H.264AVC, the “stream_type” is written as “0x1B”. With this structure, the digital TV can recognize, before accessing the main stream, whether or not the main stream can be used.

A description element “parent_CA_flag” indicates whether or not the sub stream is to be decoded by using the ECM of the parent main stream when playing back only the sub stream is not possible. A value “0” indicates that the sub stream has not been encrypted, or that the sub stream is to be decoded in accordance with information described in “CA_descriptor( )” placed in the second loop of the PMT in which information of the sub stream is described. A value “1” indicates that the sub stream is to be decoded by using the ECM of the parent main stream. This eliminates the need to perform the complicated operation of scrambling the main and sub streams by using different keys, prevents a processing load from being imposed, and prevents the sub stream from being played back in a manner not intended by the transmitter thereof in the case where the digital TV receives the sub stream separately from the main stream.

A description element “explicit_CA_flag” indicates whether or not the “ECM_PID” is described in the descriptor itself in the case where the ECM of the parent main stream is used when the sub stream is decoded. A value “0” indicates that the sub stream is to be decoded in accordance with the ECM that is the same as the ECM of the main stream, namely, information described in “CA_descriptor( )” placed in the second loop of the PMT in which information of the main stream is described. A value “1” indicates that the sub stream is to be decoded in accordance with the ECM that is indicated by the “ECM_PID” located after this, and is included in the TS containing the main stream. This allows for a flexible billing system where the main stream and the sub stream may be included in the same billing, or the sub stream may be purchased separately in addition to main stream.

A description element “ECM_PID” is used to clearly specify the ECM of the parent main stream when the sub stream is decoded.

The “PCR_location_flag” and subsequent description elements are the same as those illustrated in FIG. 3, and explanation thereof is omitted here.

As described above, by adding a new descriptor “service_subset_ES_descriptor( )”, the digital TV 300, upon receiving a sub stream, can identify a main stream that can be used with the received sub stream.

Furthermore, by including information concerning the independent playback, such as “dependency_flag”, into the “service_subset_ES_descriptor( )”, it is possible to prevent a receiving-side device from erroneously playing back the sub stream independently, preventing a viewing not intended by the producer thereof from being performed.

2.6 Digital TV (Receiving Playback Device) 300

The following explains the structure of the receiving playback device 300.

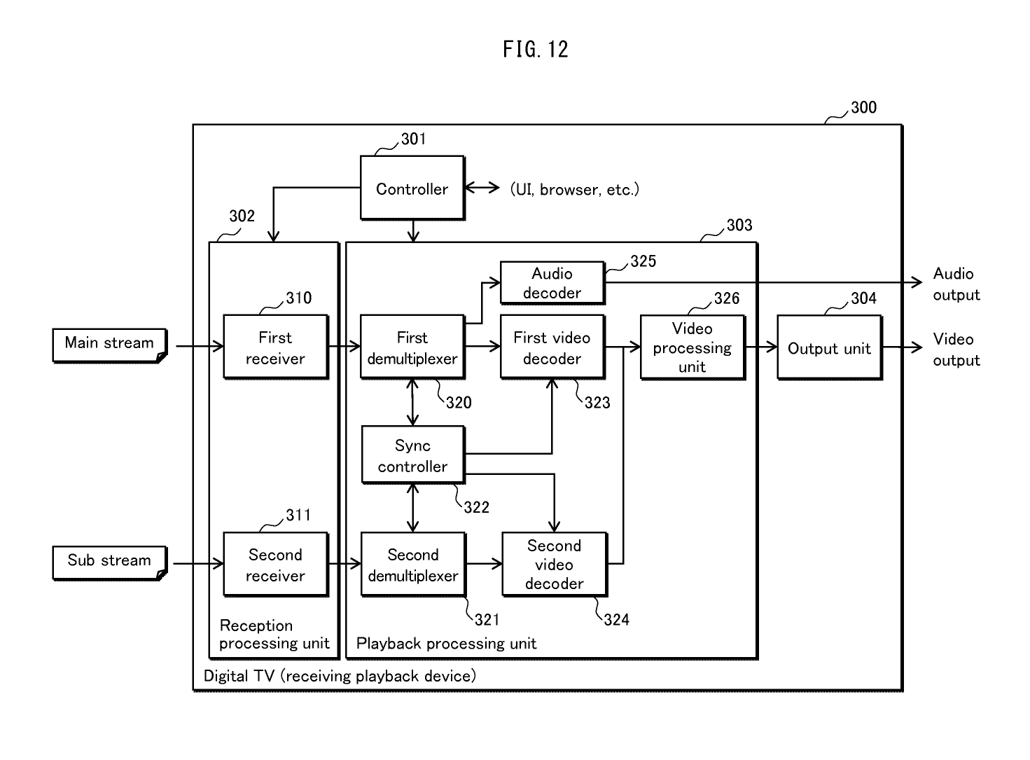

As illustrated in FIG. 12, the receiving playback device 300 includes a controller 301, a reception processing unit 302, a playback processing unit 303, and an output unit 304.

(1) Controller 301

The controller 301 controls the receiving playback device 300 as a whole.

More specifically, the controller 301 receives, via a UI, a browser or the like, an instruction to select a specific stream (broadcast channel) from the user, and instructs the reception processing unit 302 to perform a stream selection and demodulation based on the received instruction. Subsequently, the controller 301 receives, from the playback processing unit 303, a PMT contained in a TS received by the reception processing unit 302. The controller 301 analyzes the PMT to identify the PIDs of the video and audio to be played back, and notifies the playback processing unit 303 of the identified PIDs. Furthermore, the controller 301 judges whether or not there is a TS containing information that is to be played back simultaneously with the received TS, by checking whether or not the received PMT includes the above-described new descriptor. For example, the controller 301 judges whether or not there is such a sub stream by checking whether or not the received PMT contained in the received TS includes the new descriptor “external_ES_link_descriptor( )”. When it judges that the received PMT includes “external_ES_link_descriptor( )”, the controller 301 identifies the sub stream, and instructs the reception processing unit 302 to receive and decode the TS containing the identified sub stream. Furthermore, the controller 301 obtains information concerning the synchronization from the “external_ES_link_descriptor( )”, identifies a synchronization method based on the obtained information, and notifies the playback processing unit 303 of the identified synchronization method.

Note that, when the PMT contained in the received TS includes the “service_subset_ES_descriptor( )”, the controller 301 judges whether or not playing back only the sub stream is possible. When it judges that playing back only the sub stream is not possible, the controller 301 identifies the main stream and obtains the synchronization information.

(2) Reception Processing Unit 302

As illustrated in FIG. 12, the reception processing unit 302 includes a first receiver 310 and a second receiver 311.

The first receiver 310 receives and demodulates a specified transport stream (in this example, it includes the main stream), in accordance with an instruction received from the controller 301 to obtain a transport stream in the MPEG2 format, and outputs the obtained transport stream to the playback processing unit 303.

The second receiver 311 receives and demodulates a transport stream containing the sub stream, in accordance with an instruction received from the controller 301 to obtain a transport stream in the MPEG2 format, and outputs the obtained transport stream to the playback processing unit 303.

(3) Playback Processing Unit 303

As illustrated in FIG. 12, the playback processing unit 303 includes a first demultiplexer 320, a second demultiplexer 321, a sync controller 322, a first video decoder 323, a second video decoder 324, an audio decoder 325, and a video processing unit 326.

(3-1) First Demultiplexer 320

The first demultiplexer 320 demultiplexes the transport stream received from the first receiver 310, extracts therefrom the PMT pertaining to the program of the channel specified by the user, and outputs the extracted PMT to the controller 301.

Upon receiving the PIDs of the specified video and audio and the like from the controller 301, the first demultiplexer 320 extracts, from the transport stream received from the first receiver 310, an ES of video (in this example, the left-eye video stream, namely, the main stream) and an ES of audio that match the PIDs. The first demultiplexer 320 outputs the main stream and the audio ES in sequence to the first video decoder 323 and the audio decoder 325, respectively.

Furthermore, in the case where the main and sub streams are played back simultaneously, when the synchronization is performed based on the main stream, the first demultiplexer 320 extracts PCRs from the main stream in accordance with an instruction from the controller 301, and outputs the extracted PCRs in sequence to the sync controller 322.

(3-2) Second Demultiplexer 321

Upon receiving the PIDs of the specified video and audio and the like from the controller 301, the second demultiplexer 321 extracts, from the transport stream received from the second receiver 311, an ES of video (in this example, the right-eye video stream, namely, the sub stream) and an ES of audio that match the PIDs. The second demultiplexer 321 outputs the extracted video ES in sequence to the second video decoder 324.

Furthermore, in the case where the main and sub streams are played back simultaneously, when the synchronization is performed based on the sub stream, the second demultiplexer 321 extracts PCRs from the sub stream in accordance with an instruction from the controller 301, and outputs the extracted PCRs in sequence to the sync controller 322.

Note that, when the second demultiplexer 321 receives a transport stream from the second receiver 311 before it receives a video PID from the controller 301, the second demultiplexer 321 demultiplexes the received transport stream, extracts a PMT concerning the program of the channel specified by the user, and outputs the PMT to the controller 301.

(3-3) Sync Controller 322

The sync controller 322 receives a specified synchronization method from the controller 301.

When the received synchronization method is to use a PCR of the main stream, the sync controller 322 obtains the PCR from the first demultiplexer 320. The sync controller 322 generates system clocks for the main stream from the obtained PCR, and outputs the generated system clocks in sequence to the first video decoder 323. The sync controller 322 generates system clocks for the sub stream by using the system clocks for the main stream in accordance with an instruction from the controller 301, and outputs the generated system clocks in sequence to the second video decoder 324. For example, when the PCR of the main stream is applied to the sub stream as well by using the offset value, the sync controller 322 generates the system clock for the sub stream by adding or subtracting the offset value specified to the system clock for the main stream.

When the synchronization method is to use a PCR of the sub stream, the sync controller 322 obtains the PCR from the second demultiplexer 321. The sync controller 322 generates system clocks for the sub stream from the obtained PCR, and outputs the generated system clocks in sequence to the second video decoder 324. The sync controller 322 generates system clocks for the main stream by using the system clocks for the sub stream in accordance with an instruction from the controller 301, and outputs the generated system clocks in sequence to the first video decoder 323.

When the synchronization is performed by using none of the main and sub streams (for example, by using synchronization track information), the sync controller 322 generates system clocks for the main and sub streams in accordance with an instruction from the controller 301, and outputs, in sequence, system clocks for the main stream to the first video decoder 323, and system clocks for the sub stream to the second video decoder 324.

(3-4) First Video Decoder 323

The first video decoder 323 references the system clocks for the main stream output from the sync controller 322 in sequence, and decodes the video ES (the main stream), which is output from the first demultiplexer 320 in sequence, at the decoding timing described in the main stream. The first video decoder 323 then outputs the decoded main stream to the video processing unit 326 at the output timing described in the main stream.

(3-5) Second Video Decoder 324

The second video decoder 324 references the system clocks for the sub stream output from the sync controller 322 in sequence, and decodes the video ES (the sub stream), which is output from the second demultiplexer 321 in sequence, at the decoding timing described in the sub stream. The second video decoder 324 then outputs the decoded sub stream to the video processing unit 326 at the output timing described in the sub stream.

(3-6) Audio Decoder 325

The audio decoder 325 generates audio data by decoding the audio ES received in sequence from the first demultiplexer 320. The audio decoder 325 then outputs the generated audio data as the audio.

(3-7) Video Processing Unit 326

The video processing unit 326, upon receiving an instruction from the controller 301 in correspondence with the use of the sub stream, processes the videos output from the first video decoder 323 and the second video decoder 324 in accordance with the received instruction, and outputs the processed videos to the output unit 304.

For example, when the videos respectively correspond to the two views in the two-eye type stereoscopic video, the video processing unit 326 overlays the videos output from the first video decoder 323 and the second video decoder 324 with each other. As the overlay method, for example, in the case of a 3D display by the active shutter method, the video processing unit 326 displays the input videos alternately, and at the same time, closes the liquid crystal shutters of the 3D glasses for the right eye and left eye alternately in synchronization with the alternate displays. Also, in the case of a 3D display by the passive method, the video processing unit 326 overlays the input videos for each line on the display in the polarization directions set for each line in correspondence with the left and right eyes. Furthermore, in the case of the HDMI or the like that is presumed to output data to outside, the video processing unit 326 overlays the videos in accordance with a 3D format that is supported by the output-destination display (for example, the Frame Packing for outputting full-resolution images for left and right alternately, or the Side-by-Side for compressing and overlaying images in the horizontal direction).

(4) Output Unit 304

The output unit 304 outputs the videos received from the video processing unit 326 to a display (not illustrated).

2.7 Operation

The following explains the operation of each device. Note that, for convenience of explanation, it is assumed that the type of the sub stream is set as “stream_type=0x80” (the sub stream represents one of the two views that is different from the view represented by the main stream in the two-eye type stereoscopic video).

(1) Operation of Transmission Device 100

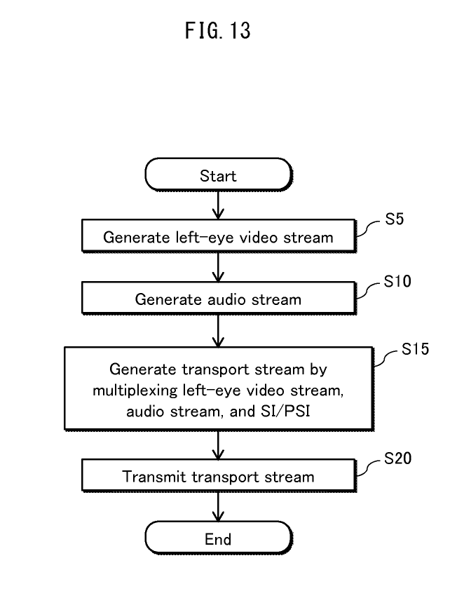

The following explains the operation of the transmission device 100 with reference to the flowchart illustrated in FIG. 13.

The left-eye video encoder 101 generates the left-eye video stream by encoding a plurality of left-eye video images (pictures) of one program by an encoding method such as MPEG-2 or MPEG-4, and writes the generated left-eye video stream onto the left-eye video stream storage 103 (step S5).

The audio encoder 102 generates the audio stream by compress-encoding the audio data, and writes the generated audio stream onto the audio stream storage 104 (step S10).

The multiplexer 106 generates a transport stream in the MPEG2-TS format by multiplexing the left-eye video stream, the audio stream, the SI/PSI, which is stored in the information holder 105, and the like (step S15), and transmits the generated transport stream via the transmitter 107 (step S20).

(2) Operation of Transmission Device 200

With regard to the operation of the transmission device 200, only the differences from the transmission device 100 are explained.

As one of the differences, in step S5, the right-eye video encoder 201 generates the right-eye video stream.

As another difference, step S10 is not executed, and when a transport stream is generated in step S10, the multiplexer 206 multiplexes the right-eye video stream, the SI/PSI stored in the information holder 205, and the like.

(3) Operation of Receiving Playback Device 300

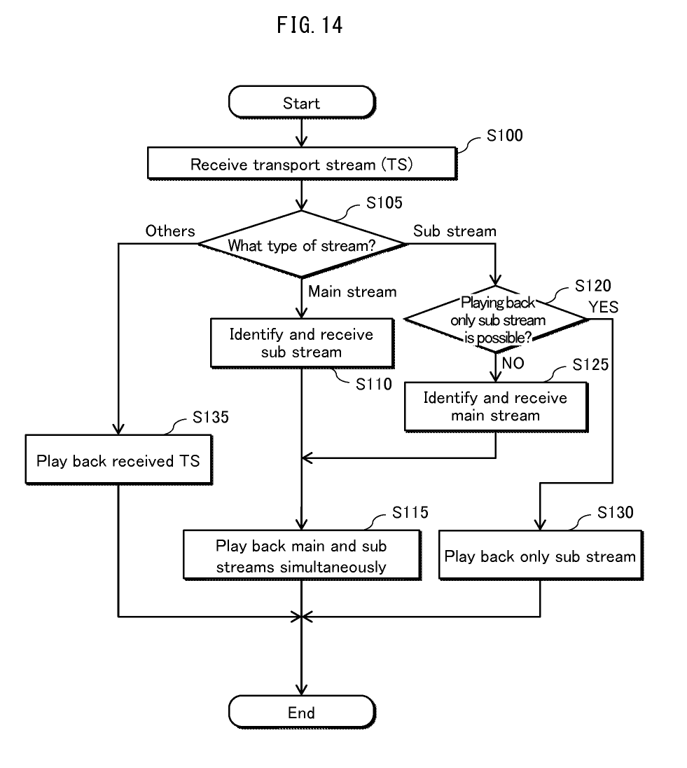

The following explains the operation of the receiving playback device 300 with reference to the flowchart illustrated in FIG. 14. Note that, for convenience of explanation, it is assumed that the main stream is received by the first receiver 310 and the sub stream is received by the second receiver 311.

The reception processing unit 302 receives a transport stream (TS) of a channel specified by the user (step S100).

The controller 301 judges, by using the PMT included in the received TS, what type of stream is contained in the received TS: the main stream; the sub stream; or none of these (step S105). More specifically, the controller 301 judges that the TS contains the main stream when the new descriptor “external_ES_link_descriptor( )” is described in the PMT included in the received TS, and judges that the TS contains the sub stream when the new descriptor “service_subset_ES_descriptor( )” is described in the PMT. Furthermore, the controller 301 judges that the TS is a normal TS when any of the new descriptors is not described in the PMT.

When the controller 301 judges that the TS contains the main stream (step S105: “Main stream”), the controller 301 identifies a sub stream by referencing the description content of the “external_ES_link_descriptor( )”, and instructs the second receiver 311 to receive a TS containing the identified sub stream, and the second receiver 311 receives the TS containing the sub stream based on the instruction from the controller 301 (step S110). More specifically, the controller 301 recognizes the method for obtaining the sub stream by referencing “TS_location_type”, “transport_steram_id”, “program_number”, “ES_PID”, “transport_stream_location”, and “uri_char”. More specifically, when “TS_location_type” has a value “00” or “01”, the controller 301 determines that the sub stream is transferred by broadcasting and instructs the second receiver 311 to receive and demodulate the broadcast waves transferring the sub stream by specifying “transport_stream_id” and “transport_stream_location”. The controller 301 further instructs the second demultiplexer 321 to extract the sub stream (the ES of right-eye video) from the demodulated transport stream by specifying “program_number” and “ES_PID”. Also, when “TS_location_type” has a value “10”, the controller 301 determines that the sub stream is obtained via a communication network and instructs the second receiver 311 to obtain a transport stream containing the sub stream from the communication network by specifying “uri_char”. The controller 301 further instructs the second demultiplexer 321 to extract the sub stream from the obtained transport stream by specifying “program_number” and “ES_PID”. In accordance with the instruction from the controller 301, the second receiver 311 receives and demodulates the sub stream, and the second demultiplexer 321 extracts a video ES (the sub stream) by demultiplexing the obtained transport stream and outputs the extracted ES to the second video decoder 324 in sequence. Note that only the main stream may be played back until the sub stream is obtained. Note that it may be set in advance whether the sub stream is obtained to be used simultaneously with the main stream, or only the main stream is used independently. Alternatively, either of them may be selected based on the result of the question to the user.

The playback processing unit 303 simultaneously plays back the received main and sub streams based on the instruction from the controller 301 (step S115). More specifically, when “external_ES_link_descriptor( )” has been obtained, the controller 301 first identifies the synchronization method by referencing “sync_reference_type” and “PCR_location_flag” and the subsequent fields. For example, when “sync_reference_type” is “01”, “PCR_location_flag” is “0”, “explicit_PCR_flag” is “0”, and “PCR_offset_flag” is “1”, the controller 301 interprets that the PCR described in the PMT of the main stream is applied to the sub stream by using the offset value, and instructs the sync controller 322 to perform that process. The sync controller 322, based on the identified synchronization method, extracts the PCR from the main stream by referencing “PCR_PID”, generates the system clocks for the main and sub streams by using the extracted PCR, and outputs, in sequence, system clocks for the main stream to the first video decoder 323, and system clocks for the sub stream to the second video decoder 324. Furthermore, the controller 301 instructs the first demultiplexer 320 to extract the main stream from the TS received by the first receiver 310. The controller 301 obtains information concerning the use of the sub stream by referencing “stream_type_flag” and “stream_type”, and instructs the playback processing unit 303 to perform a process corresponding to the obtained information. For example, when “stream_type” is “0x80”, the controller 301 interprets that the main stream and the sub stream respectively correspond to the two views in the two-eye type stereoscopic video, and instructs the playback processing unit 303 to perform a corresponding process. Based on the instruction from the controller 301, the first video decoder 323 of the playback processing unit 303 generates the left-eye video stream from the main stream, the second video decoder 324 generates the right-eye video stream from the sub stream, and the video processing unit 326 performs the process for playing back the generated left-eye and right-eye video streams in the 3D display.

When the controller 301 judges that the TS contains the sub stream (step S105: “Sub stream”), the controller 301 judges whether or not playing back only the sub stream is possible by referencing “service_subset_ES_descriptor( )” (step S120). More specifically, the controller 301 makes the above-described judgment by referencing “dependency_flag” in “service_subset_ES_descriptor( )”.

When it judges that playing back only the sub stream is not possible (step S120: “No”), the controller 301 identifies a main stream by referencing “service_subset_ES_descriptor( )”, and instructs the first receiver 310 to receive a TS containing the identified main stream, and the first receiver 310 receives the TS containing the main stream based on the instruction from the controller 301 (step S125). Subsequently, the control proceeds to step S115.

When it judges that playing back only the sub stream is possible (step S120: “Yes”), the controller 301 plays back only the sub stream (step S130). Note that it may be set in advance whether the main stream is obtained to be used simultaneously with the sub stream, or only the sub stream is used independently. Alternatively, either of them may be selected based on the result of the question to the user.

When it is judged that none of the main stream and the sub stream is contained in the received TS (step S105: “Others”), the playback processing unit 303 generates the video and audio from the received TS and outputs the video and audio to the output unit 304, namely, plays back the received TS (step S135).

### 3. Embodiment 2

In Embodiment 1 described above, programs are transmitted over broadcast waves. In Embodiment 2, programs are transmitted by the IP (Internet Protocol) broadcast.

A program distribution system in the present embodiment includes, as is the case with Embodiment 1, a transmission device 1100 for transmitting the main stream, a transmission device 1200 for transmitting the sub stream, and a receiving playback device 1300.

Note that, as is the case with Embodiment 1, the main stream is the left-eye video stream, and the sub stream is the right-eye video stream.

The following explains the structure of each device, centering on the differences from Embodiment 1. Functional structures that are the same as those in Embodiment 1 are assigned the same reference signs, and the explanation thereof is omitted.

3.1 Transmission Device 1100

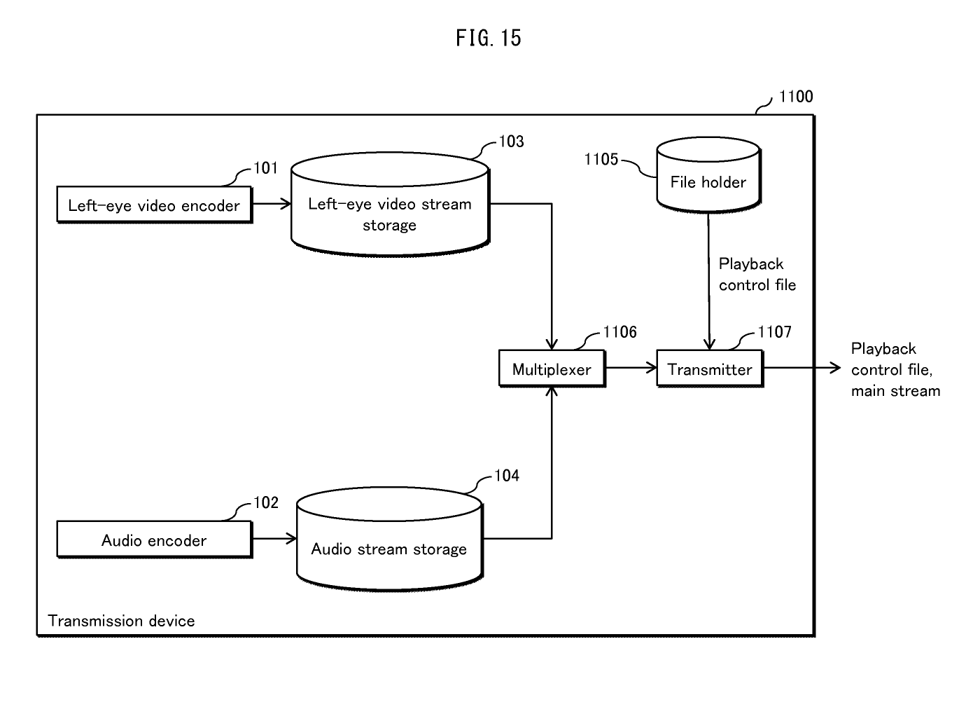

As illustrated in FIG. 15, the transmission device 1100 includes the left-eye video encoder 101, the audio encoder 102, the left-eye video stream storage 103, the audio stream storage 104, a file holder 1105, a multiplexer 1106, and a transmitter 1107.

(1) File Holder 1105

The file holder 1105 holds a playback control metafile that is transmitted prior to a transmission of a video stream and the like in the video-on-demand service on the IP or the like. The playback control metafile is defined in the Codec Part of the “Streaming Specification: Digital Television Network Functional Specifications” (Net TV Consortium).

In the present embodiment, a new element “external_ES_link_info”, in which the reference information of the sub stream that is transferred in a different TS from the main stream is described, is added in the ERI (Entry Resource Information) that contains information of the main stream and is included in the playback control metafile. Note that the new element “external_ES_link_info” is explained below. Note that the playback control metafile may be created by an external device or the transmission device 1100.

With this structure, during viewing of a video stream by the video-on-demand service on the IP, before the contents of the main stream are analyzed, a sub stream that can be used simultaneously therewith can be identified.

(2) Multiplexer 1106

The multiplexer 1106 generates a TS in the MPEG2-TS format by multiplexing the left-eye video stream (the main stream) stored in the left-eye video stream storage 103, the audio stream stored in the audio stream storage 104 and the like, and transmits the generated TS via the transmitter 1107.

(3) Transmitter 1107

The transmitter 1107 transmits the playback control metafile held by the file holder 1105, and transmits the TS in the MPEG2-TS format generated by the multiplexer 1106.

3.2 External_ES_link_info

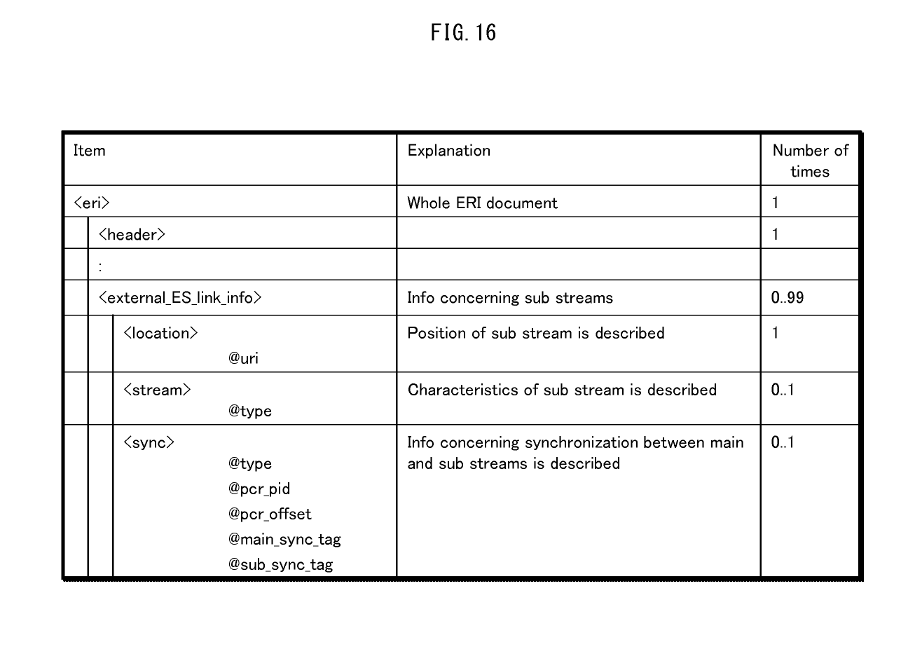

FIG. 16 illustrates the items of “external_ES_link_info”.

An element “external_ES_link_info” is information concerning one or more sub streams.

An element “location” indicates the location of the sub stream on a broadcast, communication or storage medium. Note that the location of the sub stream is described in the URI format in an attribute “uri”. This allows for the receiving-side device to recognize how the sub stream is accessible. For example, in the case where the sub stream is transferred by broadcast, for example, according to the ARIB STD-B24, a value “arib://0001.0002.0003.0004/05” indicates that the sub stream is contained in an ES that is broadcast (transferred) on the conditions: network_id=0x0001, transport_stream_id=0x0002, service_id=0x0003, event_id=0x0004, and component_tag=0x05. Also, when the sub stream is accessible by a medium other than broadcast, the description is the same as the description in the “uri_char” explained in Embodiment 1.

An element “stream” indicates the characteristics of the sub stream. In an attribute “type”, the stream type of the sub stream is described by a value defined in “ISO/IEC 13818-1”. For example, H.264AVC is described as “1b”. With this structure, the receiving-side device can recognize, before accessing the sub stream, whether or not the sub stream can be used. Note that, as is the case with the “stream_type” explained in Embodiment 1, the attribute “type” may be used to specify the use of the sub stream.

In an element “sync”, information concerning synchronization between the main and sub streams is described. The element “sync” includes attributes “type”, “pcr_pid”, “pcr_offset”, “main_sync_tag”, and “sub_sync_tag”.

The attribute “type” in the element “sync” indicates whether or not there is a means for synchronizing the main stream and the sub stream, and indicates the method therefor. When the attribute “type” has a value “pcr_main”, it indicates that the PCR of a program that includes the main stream is used. When the attribute “type” has a value “pcr_sub”, it indicates that the PCR of a program that includes the sub stream is used. When the attribute “type” has a value “independent”, it indicates that the synchronization is performed by using an independent synchronization track. When no value is described in the attribute “type”, it indicates that the receiving-side device does not synchronize the main stream and the sub stream, decoding and display of the main stream are performed in accordance with the PCR in the main stream, and decoding and display of the sub stream are performed in accordance with the PCR in the sub stream. By referencing this value, the receiving-side device can recognize whether or not there is a means for synchronizing the main stream and the sub stream, and recognize the method therefor.

The attribute “pcr_pid” is used to clearly specify “PCR_PID” when the attribute “type” is “pcr_main” or “pcr_sub”. For example, when a value “1 db” is described in the attribute “pcr_pid”, a PCR whose PID is “0x01DB” is referenced. When no value is described in the attribute “pcr_pid”, “PCR_PID” described in the PMT of that stream is used. With this structure, the receiving-side device can recognize whether to use a PCR unique to the synchronous playback when it performs the synchronous playback, and if it uses the PCR, it can recognize the PID of the PCR.

The attribute “pcr_offset” has an offset value, when the attribute “type” is “pcr_main” or “pcr_sub” and the offset value is added for the PCR to be referenced. The offset value described there is a hexadecimal integer in a range from “−200000000” to “200000000”. For example, when the attribute “type” in the element “sync” is “pcr_main” and the PCR in the main stream is used, the receiving-side device uses a value that is obtained by offsetting the PCR in the main stream in accordance with the value in the attribute “pcr_offset” when it decodes and displays the sub stream. When the attribute “type” in the element “sync” is “pcr_sub” and the PCR in the sub stream is used, the receiving-side device uses a value that is obtained by offsetting the PCR in the sub stream in accordance with the value in the attribute “pcr_offset” when it decodes and displays the main stream. In this way, by specifying the attribute “pcr_offset”, it is possible to realize a synchronous playback even when the main stream and the sub stream do not have the same start value of the PCRs to be referenced.

The attribute “main_sync_tag” indicates the value of “component_tag” of the synchronization track of the main stream when the attribute “type” is “independent”.

The attribute “main_sync_tag” indicates the value of “component_tag” of the synchronization track of the sub stream when the attribute “type” is “independent”.

By using the “main_sync_tag” and “sub_sync_tag”, it is possible to synchronize the main stream and the sub stream regardless of the values of the PCRs.

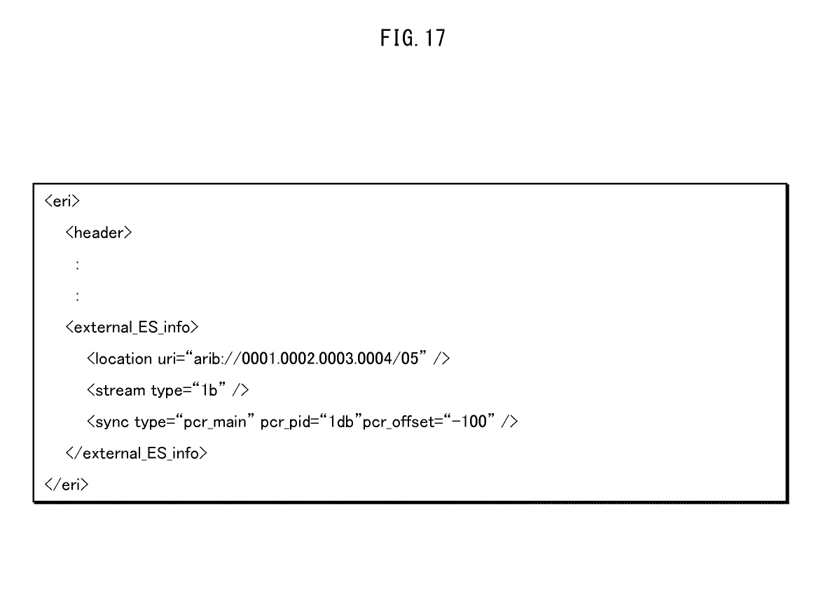

FIG. 17 illustrates a description example of the element “external_ES_link_info”. FIG. 17 indicates that the sub stream is located at “arib://0001.0002.0003.0004/05” as indicated by the element “location”. Furthermore, the attribute “type” in the element “stream” is “1b”. This indicates that the sub stream is in the H.264AVC format. Furthermore, the element “sync” indicates that the PCR in the main stream is used to synchronize the main stream and the sub stream, that the PID of the PCR to be used is “0x01DB”, and that a corresponding value of the sub stream is obtained by adding an offset value “−100” to the PCR of the main stream.

3.3 Transmission Device 1200

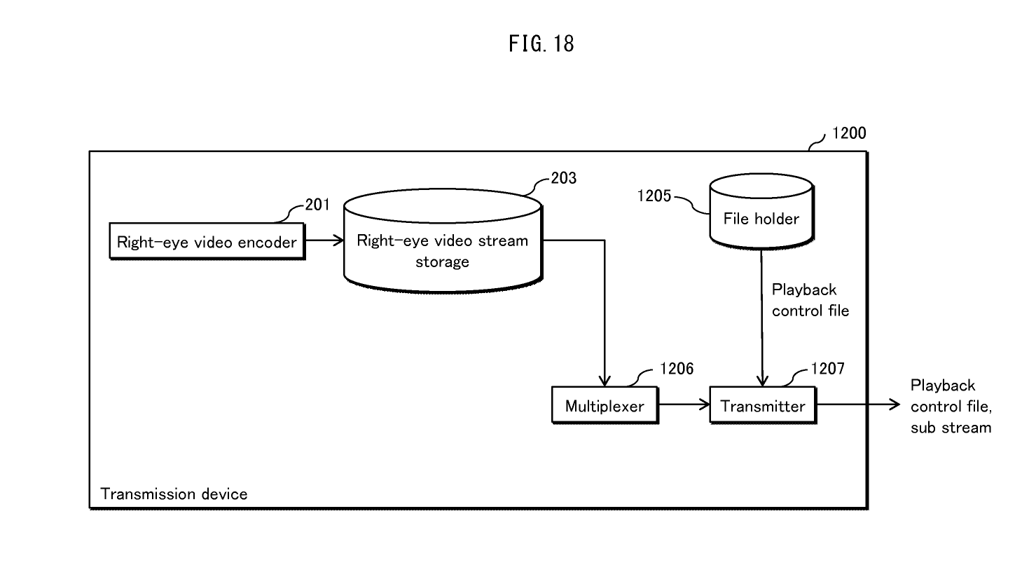

As illustrated in FIG. 18, the transmission device 1200 includes the right-eye video encoder 201, the right-eye video stream storage 203, an information holder 1205, a multiplexer 1206, and a transmitter 1207.

(1) File Holder 1205

The file holder 1205 holds a playback control metafile that is transmitted prior to a transmission of a video stream and the like in the video-on-demand service on the IP or the like. The playback control metafile is defined in the Codec Part of the “Streaming Specification: Digital Television Network Functional Specifications” (Net TV Consortium).

In the present embodiment, a new element “subset_service_ES_info”, in which the reference information of the main stream that is transferred in a different TS than the sub stream is described, is added in the ERI that contains information of the sub stream and is included in the playback control metafile. Note that the new element “subset_service_ES_info” is explained below.

With this structure, during viewing of a video stream by the video-on-demand service on the IP, before the contents of the sub stream are analyzed, a sub stream that can be used simultaneously therewith can be identified.

(2) Multiplexer 1206

The multiplexer 1206 generates a TS in the MPEG2-TS format by multiplexing the right-eye video stream (the sub stream) stored in the right-eye video stream storage 203 and the like, and transmits the generated TS via the transmitter 1207.

(3) Transmitter 1207

The transmitter 1207 transmits the playback control metafile held by the file holder 1205, and transmits the TS in the MPEG2-TS format generated by the multiplexer 1206.

3.4 Regarding “subset_service_ES_info”

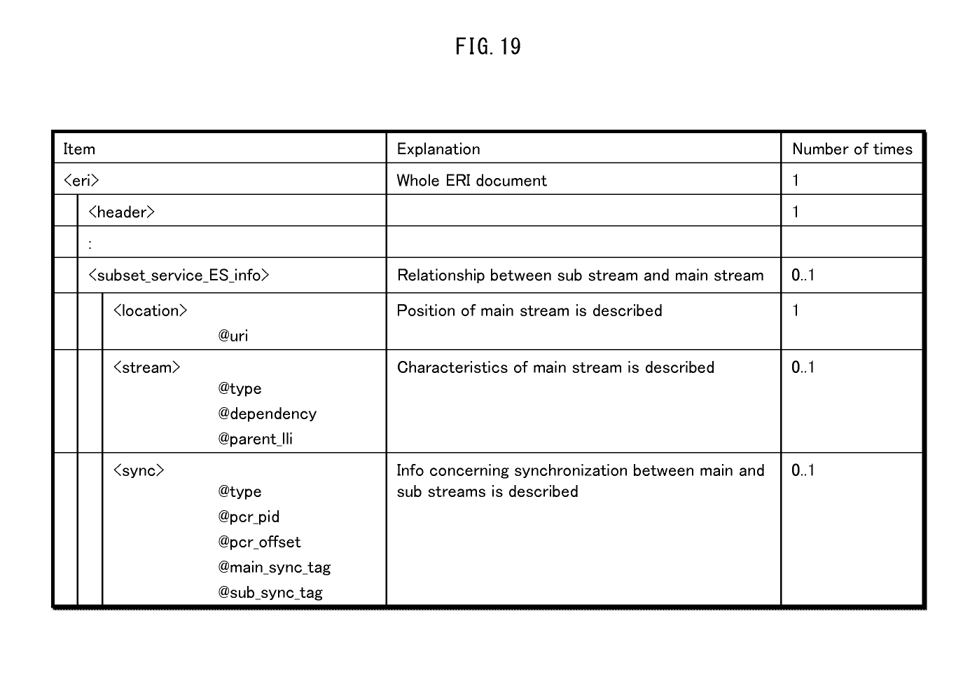

FIG. 19 illustrates the items of “subset_service_ES_info”.

An element “subset_service_ES_info” indicates the relationship between the sub stream and the main stream.

An element “location” indicates the location of the main stream on a broadcast, communication or storage medium. Note that the location of the sub stream is described in the URI format in an attribute “uri”. The attribute “uri” is described in the same manner as the attribute “uri” in the element “location” illustrated in FIG. 16. With this structure, the receiving-side device can recognize how the main stream is accessible.

An element “stream” indicates the characteristics of the main stream, and includes attributes “type”, “dependency”, and “parent_lli”.

In an attribute “type” in the element “stream”, the stream type of the main stream is described by a value defined in “ISO/IEC 13818-1”. For example, when the main stream conforms to H.264AVC, “1b” is described. With this structure, the receiving-side device can recognize, before accessing the main stream, whether or not the main stream can be used.

An attribute “dependency” indicates whether or not it is possible to play back the sub stream without depending on the main stream. When the attribute “dependency” is set to a value indicating “false”, it indicates that playing back only the sub stream is possible. When the attribute “dependency” is set to a value indicating “true”, it indicates that the sub stream can be played back only when it is used simultaneously with the main stream. With this structure, when the sub stream is accessed separately from the main stream by the receiving-side device, it is possible to permit or inhibit the playback of the sub stream in accordance with the intention of the transmitter thereof.

The attribute “parent_lli” includes information concerning LLI (License Link Information) in which reference to DRM is described. When the attribute “parent_lli” is set to a value indicating “false”, it indicates that the LLI in the playback control metafile of the sub stream is used. When the attribute “paren_lli” is set to a value indicating “true”, it indicates that the LLI in the playback control metafile of the main stream is used. This eliminates the need to perform the complicated operation of encrypting the main and sub streams by using different keys, prevents a processing load from being imposed, and prevents the sub stream from being played back in a manner not intended by the transmitter thereof in the case where the receiving-side device receives the sub stream separately from the main stream.

An element “sync” here is the same as the element “sync” illustrated in FIG. 16, and explanation thereof is omitted here.

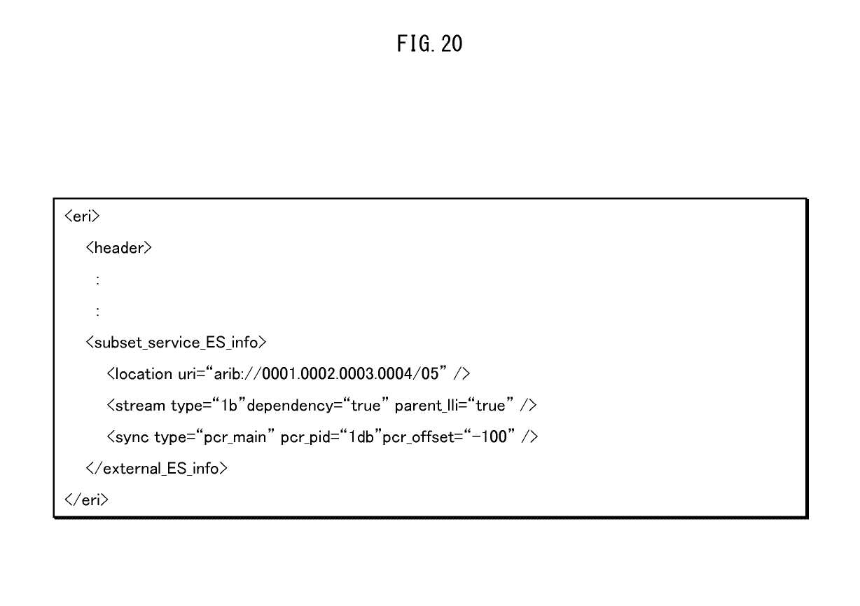

FIG. 20 illustrates a description example of the element “subset_service_ES_info”. FIG. 20 indicates that the main stream is located at “arib://0001.0002.0003.0004/05” as indicated by the element “location”. The attribute “type” in the element “stream” indicates that the main stream is in the H.264AVC format; the attribute “dependency” indicates that the sub stream can be played back only when it is used simultaneously with the main stream; and the attribute “paren_lli” indicates that the LLI in the playback control metafile of the main stream is used to reference the DRM. Furthermore, the element “sync” indicates that the PCR in the main stream is used to synchronize the main stream and the sub stream, that the PID of the PCR to be used is “0x01DB”, and that a corresponding value of the sub stream is obtained by adding an offset value “−100” to the PCR of the main stream.

3.5 Receiving Playback Device 1300

The following explains the structure of the receiving playback device 1300.

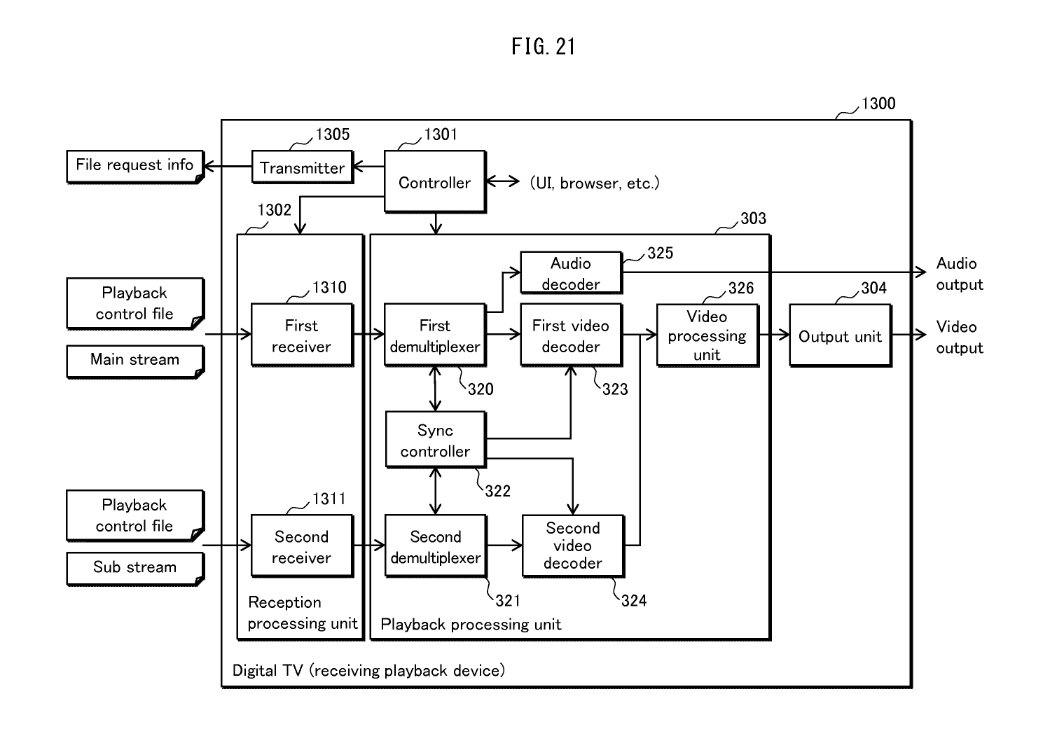

As illustrated in FIG. 21, the receiving playback device 1300 includes a controller 1301, a reception processing unit 1302, the playback processing unit 303, the output unit 304, and a transmitter 1305.

(1) Controller 1301

The controller 1301 controls the receiving playback device 1300 as a whole.

More specifically, the controller 1301 identifies a playback control metafile URL (Uniform Resource Locator) indicating a content requested to be transmitted by a user (viewer) operation. The controller 1301 generates file request information containing the identified playback control metafile URL, and transmits the generated file request information to the transmission device 1100 or 1200 via the transmitter 1305. Note that the transmission destination of the file request information is determined by a user (viewer) operation. The playback control metafile URL is identified as follows, for example. When requesting the transmission device 1100 or 1200 to transmit a content (program), the controller 1301 first receives, from the transmission devices, the playback control metafile URLs of the contents (streams) that are manage by the transmitting sides of the contents, and then displays a list of names of the contents on a display (not illustrated) of the receiving playback device 1300. Subsequently, when the user selects one name among the displayed list of content names by a user operation, the controller 1301 identifies a playback control metafile URL that corresponds to the selected content name.

Furthermore, the controller 1301 receives a playback control metafile from the reception processing unit 1302. The controller 1301 analyzes the playback control metafile to identify the PIDs of the video and audio to be played back, and notifies the playback processing unit 303 of the identified PIDs. Furthermore, the controller 1301 judges whether or not there is a TS containing information that is to be played back simultaneously with the received TS, by checking whether or not the received playback control metafile includes the above-described new descriptor. For example, the controller 1301 judges whether or not there is such a sub stream by checking whether or not the received playback control metafile includes the new descriptor “external_ES_link_info”. When it judges that the received playback control metafile includes “external_ES_link_info”, the controller 1301 identifies the sub stream. The controller 1301 transmits a transmission request of a TS containing the main stream to the transmission device 1200 via the transmitter 1305, and at the same time transmits a transmission request of a TS containing the identified sub stream to the transmission device 1200 via the transmitter 1305. The controller 1301 further instructs the reception processing unit 1302 to receive and demodulate the TS containing the sub stream. The controller 1301 further obtains information concerning synchronization from the element “external_ES_link_info”, identifies a synchronization method based on the obtained information, and notifies the playback processing unit 303 of the identified synchronization method.

When it judges that the received playback control metafile includes the new element “subset_service_ES_info”, the controller 1301 judges whether or not playing back only the sub stream is possible. When it judges that playing back only the sub stream is not possible, the controller 1301 identifies the main stream and obtains synchronization information.

(2) Transmitter 1305

Upon receiving the file request information from the controller 1301, the transmitter 1305 transmits it to the specified destination (the transmission device 1100 or 1200).

(3) Reception Processing Unit 1302

As illustrated in FIG. 21, the reception processing unit 1302 includes a first receiver 1310 and a second receiver 1311.

The first receiver 1310 receives a playback control metafile transmitted from the transmission device 1100. The first receiver 1310 receives and demodulates the TS containing the main stream, and outputs a transport stream in the MPEG2 format obtained by the demodulation to the playback processing unit 303.

The second receiver 1311 receives a playback control metafile transmitted from the transmission device 1200. The second receiver 1311 receives and demodulates the TS containing the sub stream, and outputs a transport stream in the MPEG2 format obtained by the demodulation to the playback processing unit 303.

3.6 Operation

The following explains the operation of each device. Note that, for convenience of explanation, it is assumed that the main stream is a left-eye video stream and the sub stream is a right-eye video stream.

(1) Outline of Operation

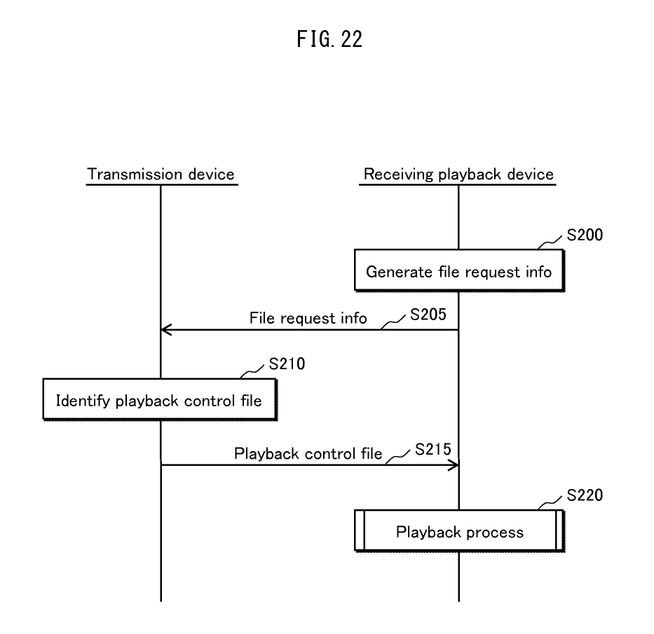

The following explains an outline of the operation of the program distribution system in the present embodiment with reference to the flowchart illustrated in FIG. 22.

The controller 1301 of the receiving playback device 1300 generates file request information containing a playback control metafile URL identifying a program (content) requested to be transmitted (step S200), and transmits the generated file request information to a transmission device specified by a user operation (the transmission device 1100 or 1200) (step S205).

The transmission device (for example, the transmission device 1100) identifies a playback control metafile that corresponds to the playback control metafile URL received from the receiving playback device 1300 (step S210), and transmits the identified playback control metafile to the receiving playback device 1300 (step S215).

Upon receiving the playback control metafile, the receiving playback device 1300 interprets the contents of the received playback control metafile, and performs a playback process based on the interpretation result (step S220).

(2) Playback Process

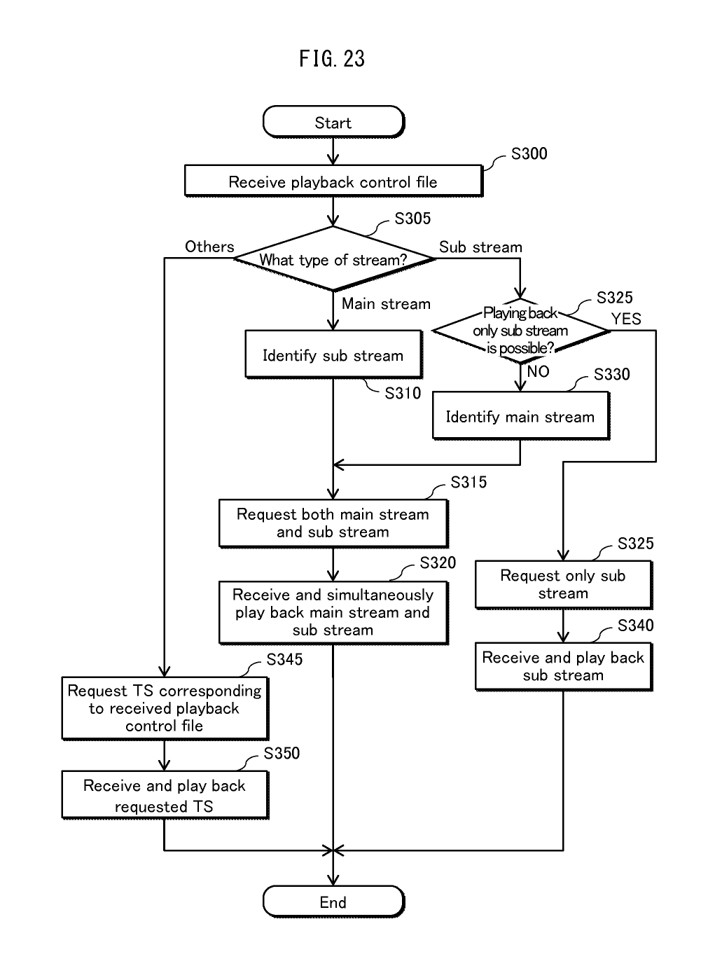

The following explains the playback process performed in step S220 of FIG. 22 with reference to the flowchart illustrated in FIG. 23.

The reception processing unit 1302 of the receiving playback device 1300 receives the playback control metafile from the transmission device (for example, the transmission device 1100) specified by the user operation (step S300).

The controller 1301 judges, by using the received playback control metafile, what type of stream is contained in the TS that corresponds to the playback control metafile: the main stream; the sub stream; or none of these (step S305). More specifically, when the new element “external_ES_link_info” is described in the received playback control metafile, the controller 1301 judges that the corresponding TS contains the main stream, and when the new element “subset_service_ES_info” is described in the received playback control metafile, the controller 1301 judges that the corresponding TS contains the sub stream. When none of the new elements is described in the received playback control metafile, the controller 1301 judges that the corresponding TS is a normal TS.

When the controller 1301 judges that the TS contains the main stream (step S305: “Main stream”), the controller 1301 identifies a sub stream by referencing the description content of the “external_ES_link_info” (step S310). More specifically, the controller 1301 identifies the method for obtaining the sub stream by referencing the attribute “ur” in the element “location”.

The controller 1301 requests the transmission device 1100 and the transmission device 1200 to transmit the main stream and the sub stream, respectively (step S315).

The playback processing unit 303 simultaneously plays back the received main and sub streams based on the instruction from the controller 1301 (step S320). More specifically, when “external_ES_link_info” has been obtained, the controller 1301 first identifies the synchronization method by referencing the element “sync”. The sync controller 322, based on the identified synchronization method, extracts the PCR from the main stream by referencing “PCR_PID”, generates the system clocks for the main and sub streams by using the extracted PCR, and outputs, in sequence, system clocks for the main stream to the first video decoder 323, and system clocks for the sub stream to the second video decoder 324. Furthermore, the controller 1301 instructs the first demultiplexer 320 to extract the main stream from the TS received by the first receiver 1310, and the second demultiplexer 321 to extract the sub stream from the TS received by the second receiver 1311. Based on the instruction from the controller 1301, the first video decoder 323 of the playback processing unit 303 generates the left-eye video stream from the main stream, the second video decoder 324 generates the right-eye video stream from the sub stream, and the video processing unit 326 performs the process for playing back the generated left-eye and right-eye video streams in the 3D display.

When the controller 1301 judges that the TS contains the sub stream (step S305: “Sub stream”), the controller 1301 judges whether or not playing back only the sub stream is possible by referencing the element “subset_service_ES_info” (step S325). More specifically, the controller 1301 may make the above-described judgment by referencing the attribute “dependency” in the element “stream” of the “subset_service_ES_info”.

When it judges that playing back only the sub stream is not possible (step S325: “No”), the controller 1301 identifies a main stream by referencing “subset_service_ES_info” (step S330). Subsequently, the control proceeds to step S315.

When it judges that playing back only the sub stream is possible (step S325: “Yes”), the controller 1301 requests the transmission device 1200 to transmit the sub stream (step S335). The second receiver 1311 receives the sub stream, and the playback processing unit 303 plays back only the sub stream (step S340).

When it is judged that none of the main stream and the sub stream is contained in the received TS (step S305: “Others”), the controller 1301 requests the transmission device (the device specified by the user operation) to transmit the sub stream (step S345). The first receiver 1310 receives the stream, and the playback processing unit 303 plays back only the received stream (step S350).

### 4. Modification 1

In the above-described embodiments, the PMT or the ERI is used to link the main stream with the sub stream, depending on the program transmission format. However, the present invention is not limited to these.

In the present modification, information that is used by the main stream to identify the sub stream is written in Service Information (SI) that is defined in “ARIB STD-B10”, not written in the PMT. More specifically, “hyperlink_descriptor( )”, which is also defined in “ARIB STD-B10” and in which reference information of the sub stream transferred in a TS different from that stream, is included in Service Description Table (SDT) that is included in the SI, or included in a descriptor loop of Event Information Table (EIT).

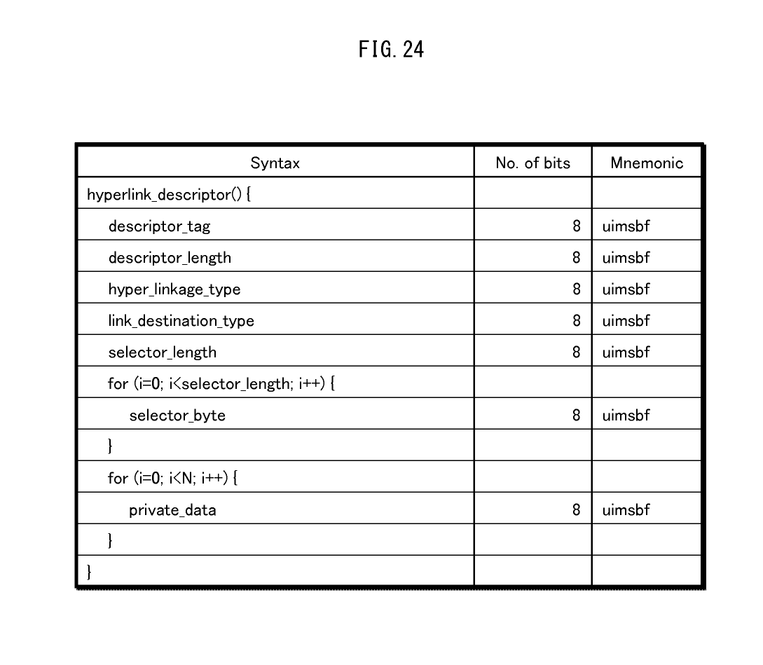

FIG. 24 illustrates one example of the data structure of “hyperlink_descriptor( )”.

A description element “descriptor_tag” includes a unique value identifying that descriptor and distinguishing it from other descriptors.

A description element “descriptor_length” indicates the number of bytes assigned to the fields of that descriptor ranging from the next field to the last field.

A description element “hyper_linkage_type” indicates the format of the link. In this example, “synchronized_stream(0x0B)” is newly defined and used.

A description element “link_destination_type” indicates a link destination type. In this example, “link_to_external_component(0x08)” is newly defined and used.

A description element “selector_length” indicates the byte length of a selector area located after this.

A description element “selector_byte” has description of a link destination in a format, which is defined for each link destination type. In this example, “link_external_component_info( )” is newly defined and used in correspondence with “link_to_external_component(0x08)”. The meaning of the “link_external_component_info( )” is explained below.

A description element “private_data” is used for future extension.

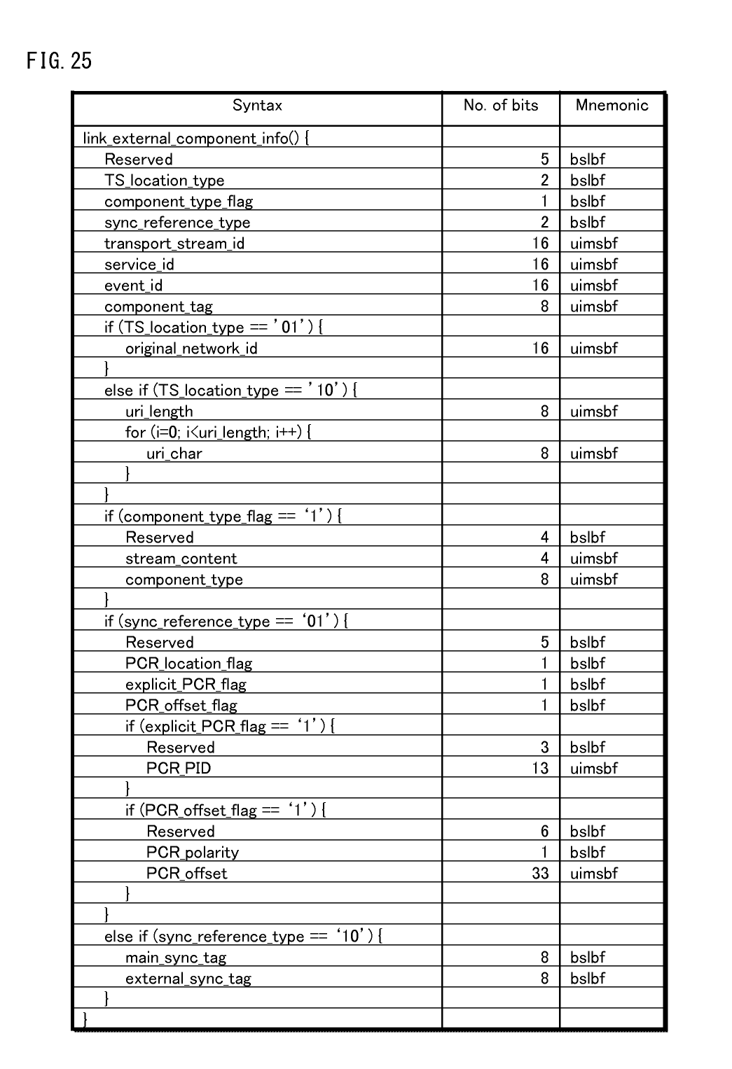

FIG. 25 illustrates one example of the data structure of “link_external_component_info( )”.

A description element “Reserved” is an area reserved for future extension, and a binary digit “1” is written therein as many times as the number of bits assigned thereto.

A description element “TS_location_type” indicates the type of the network via which the sub stream is transferred. More specifically, a value “00” indicates that the main stream is transferred via the same broadcast network as the sub stream. A value “01” indicates that the sub stream is transferred via a broadcast network that is different from a broadcast network via which the main stream is transferred, wherein the broadcast network of the sub stream is indicated by a description element “transport_stream_location” located after this. A value “10” indicates that the sub stream can be accessed by a medium other than the broadcasting, via a URI indicated by a description element “uri_char” located after this. With this structure, the receiving side device can recognize how the sub stream can be accessed.

A description element “component_type_flag” is a flag indicating whether or not description elements “stream_content” and “component_type” located after this contain description.

A description element “sync_reference_type” is the same as that illustrated in FIG. 4.

A description element “transport_stream_id” indicates the ID of a transport stream by which the referenced sub stream is transferred.

A description element “service_id” indicates the service ID of a program that includes the referenced sub stream. Note that “service_id” has the same value, indicating the same, as “program_number”. A description element “event_id” indicates the event ID of an event that includes the referenced sub stream. Note that, when an event that includes the referenced sub stream is not specified, a null value (0xffff) is stored in the “event_id”.

A description element “component_tag” indicates the component tag of the referenced sub stream. Describing the “transport_stream_id”, “service_id”, and “component_tag” makes it possible to identify an ES of a sub stream that is usable when the main stream is used. Furthermore, describing “event_id” make it possible to specify an event including a sub stream that is broadcast at a different time than an event including the main stream. In that case, the receiving-side device records one stream (the main stream or the sub stream) that is broadcast earlier than the other and then performs a synchronized playback by using the main stream or the sub stream that has been stored.

A description element “original_network_id”, in the case where the referenced sub stream is transferred via another broadcast network (for example, a satellite broadcast distinguished from the terrestrial broadcast), indicates the network via which the sub stream is transferred. With this structure, even in the case where the sub stream is transferred via a broadcast network different from the network via which the main stream is transferred, the receiving device can recognize the transfer position.

A description element “uri_length” indicates the number of bytes assigned to “uri_char” located after this.

In “uri_char”, a URI is described, wherein the URI can be used to access a TS containing the referenced sub stream when the sub stream can be accessed via a medium other than the broadcasting. The URI may be described in the same manner as in Embodiment 1, and explanation thereof is omitted here.

A description element “stream_content” indicates a type (video, audio or data) of the specified sub stream.

A description element “component_type” indicates a detailed type of the component of the specified sub stream. Describing “stream_content” and “component_type” makes it possible to recognize whether or not the receiving device can use the sub stream before the receiving device accesses the sub stream. Note that, as is the case with the “stream_type” illustrated in FIG. 4, the “stream_content” and “component_type” may be used to specify the use of the sub stream.

The “PCR_location_flag” and subsequent description elements are the same as those illustrated in FIG. 4, and explanation thereof is omitted here. Note however that the synchronization track of the main stream is described by using the “main_sync_tag” instead of the “main_sync_PID”. Note also that the synchronization track of the sub stream is described by using the “sub_sync_tag” instead of the “sub_sync_PID”.

This completes the explanation of the structure of new descriptors “hyperlink_descriptor( )” and “link_external_component_info( )”. With these descriptors, when a playback/recording reservation of a program is performed in advance, the receiving-side device (digital TV) can identify, in advance, a usable sub stream and select a stream to be played back or recorded.

### 5. Modification 2

The following explains a case where an element “object” defined by “ARIB STD-B24” is used to describe the reference information of a sub stream transferred in a different TS than the main stream, the element “object” being contained in the data broadcast that is performed in conjunction with the main stream.

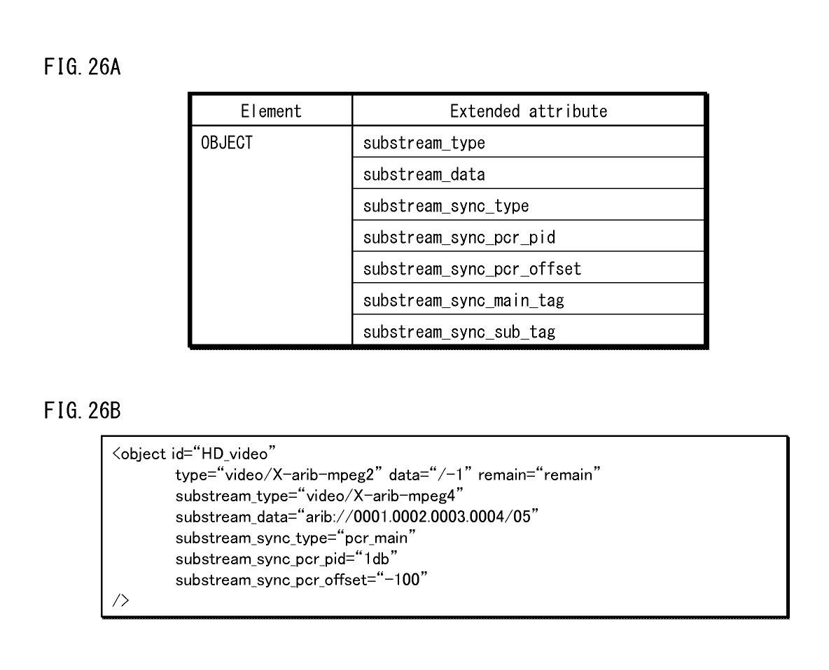

FIG. 26A illustrates a list of extended attributes used in the present modification, and FIG. 26B illustrates a description example of a data broadcast content in which the attributes are used to specify a sub stream.

FIG. 26A illustrates the extended attributes are described to specify a sub stream for the element “object” indicating the main stream.

An attribute “substream_type” indicates the MIME type of the sub stream. For example, in the case of MPEG-4 in which data is transferred over broadcast waves, “video/X-arib-mpeg4” is specified in the “substream_type”. This makes it possible to recognize whether or not the receiving device can use the sub stream before the receiving device accesses the sub stream. Note that, as is the case with the “stream_type” illustrated in FIG. 4, the attribute “stream_type” may have a value specifying the use of the sub stream.

An attribute “substream_data” indicates a URL of the sub stream. The attribute “uri” is described in the same manner as the attribute “uri” in the element “location” illustrated in FIG. 16. With this structure, the receiving side device can recognize the location of the sub stream.

An attribute “substream_sync_type” indicates whether or not there is a means for synchronizing the main stream and the sub stream, and indicates the method therefor. When the attribute “substream_sync_type” has a value indicating “pcr_main”, it indicates that the PCR of a program that includes the main stream is used. When the attribute “substream_sync_type” has a value indicating “pcr_sub”, it indicates that the PCR of a program that includes the sub stream is used. When the attribute “substream_sync_type” has a value indicating “independent”, it indicates that the synchronization is performed by using an independent synchronization track. When no value is described in the attribute “substream_sync_type”, it indicates that the receiving-side device does not synchronize the main stream and the sub stream, decoding and display of the main stream are performed in accordance with the PCR in the main stream, and decoding and display of the sub stream are performed in accordance with the PCR in the sub stream. By referencing this value, the receiving-side device can recognize whether or not there is a means for synchronizing the main stream and the sub stream, and recognize the method therefor.

An attribute “substream_sync_pcr_pid” is used to clearly specify “PCR_PID” when the attribute “substream_sync_type” is “pcr_main” or “pcr_sub”. For example, when a value “1 db” is described in the attribute “substream_sync_pcr_pid”, a PCR whose PID is “0x01DB” is referenced. When no value is described in the attribute “substream_sync_pcr_pid”, “PCR_PID” described in the PMT of that stream is used. With this structure, the receiving-side device can recognize whether to use a PCR unique to the synchronous playback when it performs the synchronous playback, and if it uses the PCR, it can recognize the PID of the PCR.

An attribute “substream_sync_pcr_offset” has an offset value, when the attribute “substream_sync_type” is “pcr_main” or “pcr_sub” and the offset value is added for the PCR to be referenced. The offset value described there is a hexadecimal integer in a range from “−200000000” to “200000000”. For example, when the attribute “substream_sync_type” is “pcr_main” and the PCR in the main stream is used, a value obtained by offsetting the PCR in the main stream in accordance with the value in “substream_sync_pcr_offset” is used to decode and display the sub stream. When the attribute “substream_sync_type” is “pcr_sub” and the PCR in the sub stream is used, a value obtained by offsetting the PCR in the sub stream in accordance with the value in “substream_sync_pcr_offset” is used to decode and display the main stream. In this way, by specifying “substream_sync_pcr_offset”, it is possible to realize a synchronous playback even when the main stream and the sub stream do not have the same start value of the PCRs to be referenced.

In an attribute “substream_sync_main_tag”, a component tag indicating the synchronization track of the main stream is described when the attribute “substream_sync_type” is “independent”.

In an attribute “substream_sync_sub_tag”, a component tag indicating the synchronization track of the sub stream is described when the attribute “substream_sync_type” is “independent”. Use of the attributes “substream_sync_main_tag” and “substream_sync_sub_tag” makes it possible to synchronize the main stream and the sub stream regardless of the values of the PCRs.

FIG. 26B illustrates a description example of a data broadcast content in which the above-described extended attributes are used to specify a sub stream.

The description in “substream_type” indicates that the sub stream is transferred over broadcast waves in the MPEG-4 format.

The description in “substream_data” indicates that the sub stream is present at a location indicated by “arib://0001.0002.0003.0004/05”.

The description in “substream_sync_type” and “substream_sync_pcr_pid” indicates that, when the main stream and the sub stream are synchronized, a PCR of a program that includes the main stream is used, and a PCR whose PID is “0x01DB” is referenced.

The description in “substream_sync_pcr_offset” indicates that, an offset value “−100” is used when the main stream and the sub stream are synchronized.

This completes the explanation of the case where reference information of a sub stream is described by using an element “object” in the data broadcast defined by “ARIB STD-B24”. With this structure, when viewing a video/audio service of the main stream by using a data broadcast content, it is possible to identify a sub stream that can be used simultaneously with the main stream.

### 6. Modification 3

The following explains a case where an element “ProgramInformation” in the metadata defined by “ETSI TS 102 822 Part3-1” is used to describe the reference information of a sub stream transferred in a different TS than the main stream, the metadata containing information of a content including the main stream that is used in the server-type broadcast. More specifically, a new element “ExternalES” is defined and described in an element “VideoAttributes” described in an element “AVAttributes” included in an element “ProgramInformation”.

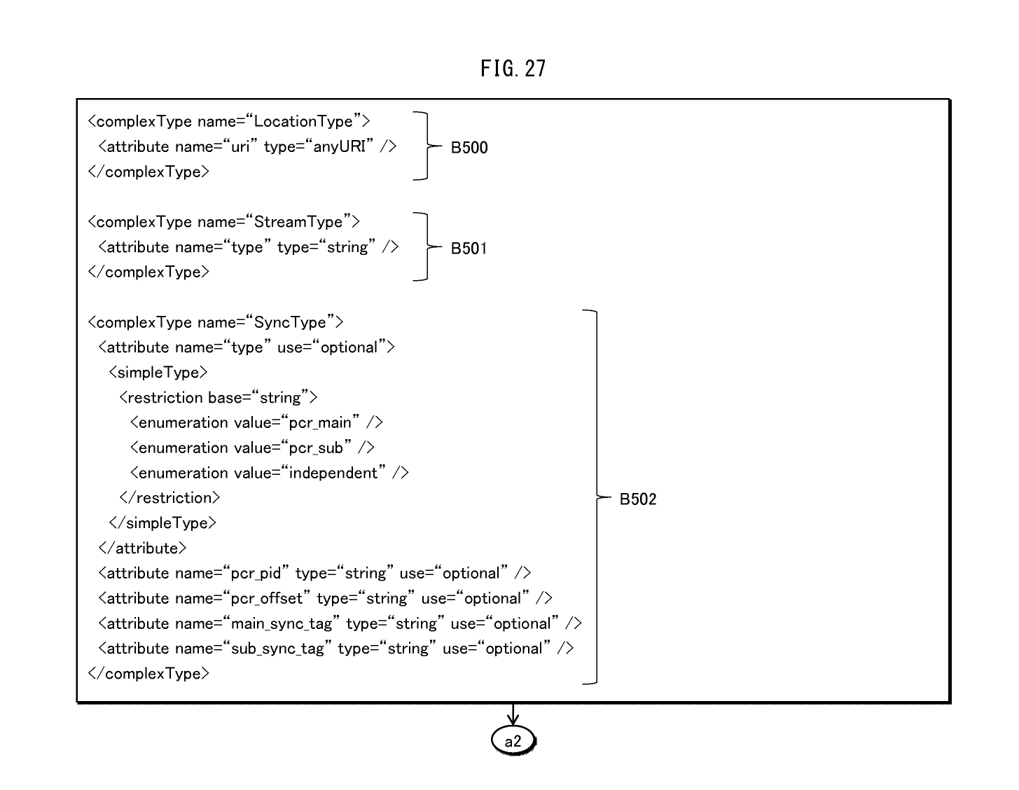

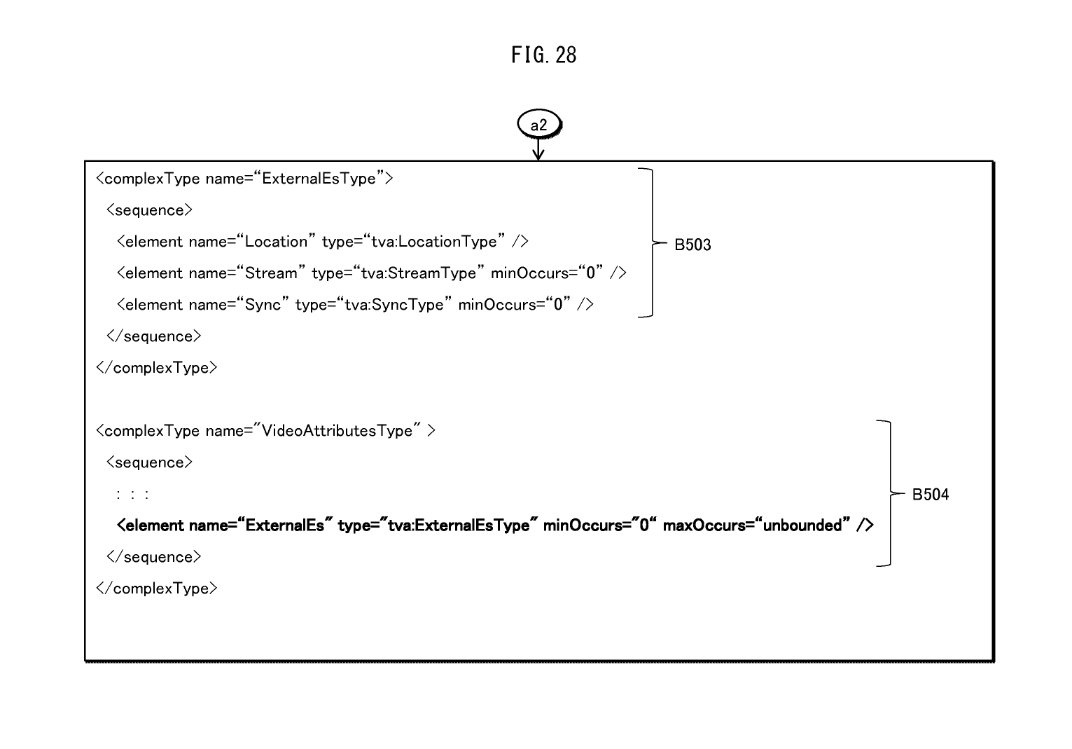

FIGS. 27 and 28 illustrate one example of the structure (schema) for defining the element “ExternalES” in the element “VideoAttributes”.

The description in a block B500 illustrated in FIG. 27 is called “LocationType”, and the location of the sub stream on a broadcast, communication, or storage medium is described therein. The location of the sub stream is described in the URI format in an attribute “uri” included in the LocationType. The attribute “uri” is described in the same manner as the attribute “uri” in the element “location” illustrated in FIG. 16, and explanation thereof is omitted here. With this structure, the receiving-side device can recognize how the sub stream can be accessed.

The description in a block B501 is called “StreamType”, and the characteristics of the sub stream is described therein. A character string representing an attribute of the sub stream is described in an attribute “type” in StreamType. More specifically, a value of “stream_type” defined in “ISO/IEC 13818-1” is described. For example, in the case of H.264AVC, “1b” is described. This makes it possible to recognize whether or not the receiving-side device can use the sub stream before the receiving-side device accesses the sub stream. Note that, as is the case with the “stream_type” illustrated in FIG. 4, the attribute “stream_type” may have a value specifying the use of the sub stream.

The description in a block B502 is called “SyncType”, and information concerning synchronization between the main stream and the sub stream is described therein.

An attribute “type” in SyncType indicates whether or not there is a means for synchronizing the main stream and the sub stream, and indicates the method therefor. When the attribute “type” has a value indicating “pcr_main”, it indicates that the PCR of a program that includes the main stream is used. When the attribute “type” has a value indicating “pcr_sub”, it indicates that the PCR of a program that includes the sub stream is used. When the attribute “type” has a value indicating “independent”, it indicates that the synchronization is performed by using an independent synchronization track. When no value is described in the attribute “type”, it indicates that the receiving device does not synchronize the main stream and the sub stream, decoding and display of the main stream are performed in accordance with the PCR in the main stream, and decoding and display of the sub stream are performed in accordance with the PCR in the sub stream. By referencing this value, the receiving-side device can recognize whether or not there is a means for synchronizing the main stream and the sub stream, and recognize the method therefor.

An attribute “pcr_pid” is used to clearly specify “PCR_PID” when the attribute “type” is “pcr_main” or “pcr_sub”. For example, when a value “1 db” is described in the attribute “pcr_pid”, a PCR whose PID is “0x01DB” is referenced. When no value is described in the attribute “pcr_pid”, “PCR_PID” described in the PMT of that stream is used. With this structure, the receiving-side device can recognize whether to use a PCR unique to the synchronous playback when it performs the synchronous playback, and if it uses the PCR, it can recognize the PID of the PCR.

The attribute “pcr_offset” has an offset value, when the attribute “type” is “pcr_main” or “pcr_sub” and the offset value is added for the PCR to be referenced. The offset value described there is a hexadecimal integer in a range from “−200000000” to “200000000”.

For example, when the attribute “sync” is “pcr_main” and the PCR in the main stream is used, the receiving-side device uses a value that is obtained by offsetting the PCR in the main stream in accordance with the value in the attribute “offset” when it decodes and displays the sub stream. When the attribute “sync” is “pcr_sub” and the PCR in the sub stream is used, the receiving-side device uses a value that is obtained by offsetting the PCR in the sub stream in accordance with the value in the attribute “pcr_offset” when it decodes and displays the main stream.

In this way, by specifying the attribute “pcr_offset”, it is possible to realize a synchronous playback even when the main stream and the sub stream do not have the same start value of the PCRs to be referenced.

The attribute “main_sync_tag” indicates the value of “component_tag” of the synchronization track of the main stream when the attribute “type” is “independent”.

The attribute “sub_sync_tag” indicates the value of “component_tag” of the synchronization track of the sub stream when the attribute “type” is “independent”. By using the “main_sync_tag” and “sub_sync_tag”, it is possible to synchronize the main stream and the sub stream regardless of the values of the PCRs.

The description in a block B503 is called “ExternalEsType” and information concerning the sub stream is described therein. ExternalEsType includes the element “Location” of LocationType, the element “Stream” of StreamType, and the element “Sync” of SyncType. These elements are explained in the above, and explanation thereof is omitted here.

The description in a block B504 is called “VideoAttributesType”, and a new element “ExternalEs” of ExternalEsType is added therein.

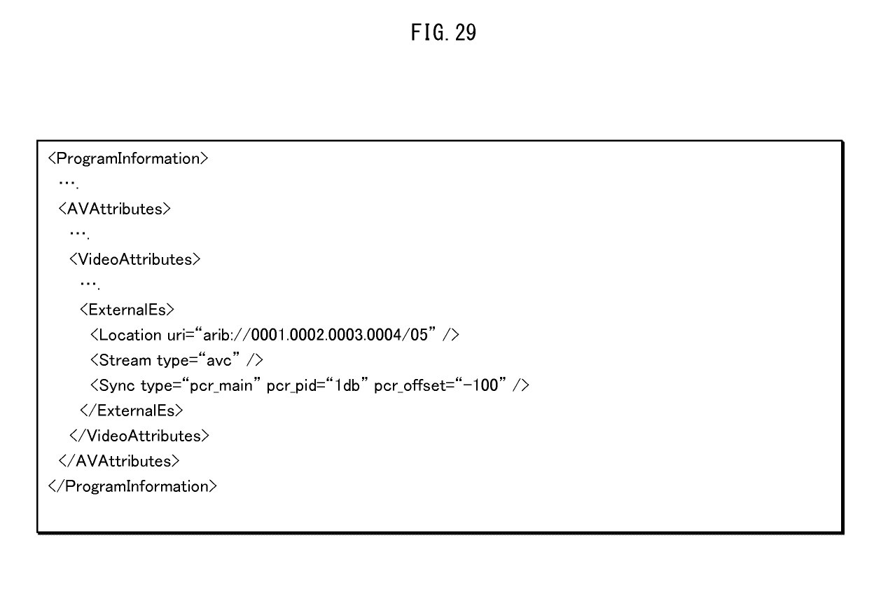

FIG. 29 illustrates a description example of ERI for specifying a sub stream by using the new element “ExternalEs”.

In the description illustrated in FIG. 29, description of the new element extends from <ExternalEs> to </ExternalEs>.

The description in the element “Location” indicates that the sub stream is present at a location indicated by “arib://0001.0002.0003.0004/05”.

The description in the element “Stream” indicates that the stream type is H.264AVC.

The description in the attributes “type”, “pcr_pid” and “pcr_offset” in the element “Sync” indicates that, when the main stream and the sub stream are synchronized, a PCR of a program that includes the main stream is used, a PCR whose PID is “0x01DB” is referenced, and an offset value “−100” is used.

This completes the explanation of the case where the element “ExternalEs” is defined in the element “VideoAttributes”, and reference information of the sub stream is described therein. With this structure, it is possible to identify a usable sub stream by using metadata, in which content information that is common to broadcast and communication can be described.

### 7. Other Modifications

The present invention is not limited to the above-described embodiments and modifications, but the following modifications, for example, are possible.

(1) According to Embodiment 1, a new descriptor “external_ES_link_descriptor( )” is described in the second loop D102 of the PMT. However, the present invention is not limited to this structure.

The descriptor “external_ES_link_descriptor( )” may be described in the first loop D100 of the PMT when, for example, the sub stream does not correspond to a specific main stream ES, but is added to a program (for example, when the sub stream is a caption ES of an added language).

This facilitates describing a sub stream corresponding to a program.

Furthermore, not limited to defining “external_ES_link_descriptor( )” newly, one or more existing descriptors may be extended to add various information described in “external_ES_link_descriptor( )” therein, or it may be added in a main stream ES and/or a sub stream ES as user-extended data.

(2) In Embodiment 2, the playback control metafile, which is defined in the Codec Part of the “Streaming Specification: Digital Television Network Functional Specifications” (Net TV Consortium), is described as a file in which the new element “external_ES_link_info( )” is added. However, not limited to this, the new element “external_ES_link_info( )” may be added in information other than the playback control metafile.

The new element “external_ES_link_info( )” may be added in meta-information for describing the attributes of video/audio streams, such as “Content Access Descriptor” defined in “Open IPTV Forum Specification Volume 5—Declarative Application Environment” or the header of “ISO/IEC 14496-12” (ISO Base Media File Format).

Similarly, the new element “subset_service_ES_info( )” may be added in meta-information for describing the attributes of video/audio streams, such as “Content Access Descriptor” defined in “Open IPTV Forum Specification Volume 5—Declarative Application Environment” or the header of “ISO/IEC 14496-12” (ISO Base Media File Format), as well as in the playback control metafile defined in the Codec Part of the “Streaming Specification: Digital Television Network Functional Specifications” (Net TV Consortium).

In the above embodiments, the new elements are described in the ERI. However, the present invention is not limited to this structure. The above-described new elements may not necessarily be described in the ERI as far as they are included in the playback control file.

(3) In Modification 1, the SI information defined in “ARIB STD-B10” is used in the explanation. However, not limited to this, an information format using the MPEG2 Private Section format, such as “ETSI EN 300 468” (DVB-SI) or “ATSC A65” (ATSC Program and System Information Protocol) may be used.

Also, instead of describing the information of the sub stream in “hyperlink_descriptor( )”, a new descriptor may be defined and equivalent information may be described in the new descriptor.

Furthermore, in Modification 2 above, the data broadcast defined in “ARIB STD-B24” is used in the explanation. However, not limited to this, a multimedia method that makes it possible to access a video object from within a document, such as “ETSI ES 202 184” (MHEG-5 Broadcast Profile), “ETSI TS 101 812” (Multimedia Home Platform), “CEA-2014” (Web4CE) or “HTML-5”, may be used.

(4) In Embodiment 1 above, the new descriptor “service_subset_ES_descriptor( )” is described in the second loop of the PMT. However, the present invention is not limited to this structure.

The new descriptor “service_subset_ES_descriptor( )” may be described in the first loop of the PMT when the program including the sub stream is composed of only the sub stream and does not include any other ES. Furthermore, not limited to defining “service_subset_ES_descriptor( )” newly, one or more existing descriptors may be extended to add various information described in “service_subset_ES_descriptor( )” therein.

(5) In the above embodiments, elements “external_ES_link_descriptor( )”, “service_subset_ES_descriptor( )”, “hyper_link_descriptor( )”, and “ExternalES” are described one for each. However, the present invention is not limited to this structure.

These elements may be described a plurality of times.

(6) In the embodiments above, the main stream is the left-eye video stream and the sub stream is the right-eye video stream. However, the combination of the main stream and the sub stream is not limited to this.

There are varieties of combinations of the main stream and the sub stream, and the “stream_type” can be used to specify use of the sub stream, such as control of 3D video (value of “stream_type”: “0x80”; “0x81”; “0x85”-“0x87”), high definition of video of the main stream (value of “stream_type”: “0x82”-“0x84”), or switching of the free viewpoint (value of “stream_type”: “0x88”-“0x8A”). For example, when the sub stream is the difference component for realizing the high-definition video of the main stream, the video processing unit adds a difference component generated by the second video decoder to the video generated by the first video decoder.

As another example, a new value may be set to define the sub stream as caption data or audio data. In that case, the receiving playback device may include: a caption data decoder for decoding caption data of the sub stream; or an audio data decoder for decoding audio data of the sub stream. When the sub stream is caption data, the video processing unit overlays the caption data decoded by the caption data decoder with the video generated by the first video decoder. Also, when the sub stream is audio data, the receiving playback device decodes the audio data included in the sub stream, and outputs the decoded audio data. Note that, when the main stream includes audio data as well, audio obtained from both the main stream and the sub stream, or audio obtained from either the main stream or the sub stream may be output in accordance with user operation.

(7) In the above-described embodiments, the main stream and the sub stream are transmitted in the same transmission format. However, the present invention is not limited to this.

The main stream and the sub stream may be transmitted in different transmission formats. For example, the main stream may be included in a transport stream containing SI/PSI such as PMT, and the sub stream may be included in a transport stream that is transmitted in the IP broadcasting, or vice versa.

(8) In the above-described embodiments, PMTs and playback control files, especially the new descriptors and new elements “external_ES_descriptor( )”, “service_subset_ES_descriptor( )”, “external_ES_link_info”, “subset_service_ES_info”, “hyper_link_descriptor( )”, “link_external_component_info( )”, “object” and “ExternalES” may be generated, for example, as follows: description elements such as descriptors are stored as parameter variables in advance in the transmission device 100 or an external device; and information related to the parameter variables is received from the user. Furthermore, the above-described method is merely an example, and other methods may be used instead.

(9) In the above-described embodiments, the receiving playback device is, as one example, a digital TV. However, the present invention is not limited to this structure. The receiving playback device may be applied to a DVD recorder, a BD (Blu-ray Disc) recorder or a set-top box.

(10) Each of the above-described devices may be a computer system composed of a microprocessor, a ROM, a RAM, a hard disk unit, a display unit, a keyboard, a mouse and the like. A computer program is stored in the RAM or the hard disk unit. The microprocessor operates in accordance with the computer program, thereby enabling that device to realize its functions. The computer program mentioned above is composed of a plurality of instruction codes which each instructs the computer to realize a predetermined function.

(11) Part or all of the structural elements constituting any of the above-described devices may be implemented in one integrated circuit.

(12) Part or all of the structural elements constituting any of the above-described devices may be composed of an IC card that is attachable to and detachable from the device, or an independent module. The IC card or the module may be a computer system composed of a microprocessor, a ROM, a RAM and the like. The IC card or the module may contain the above-described ultra multi-functional LSI. The microprocessor operates in accordance with the computer program, thereby enabling the IC card or the module to realize its functions.

(13) Each of the methods explained in the embodiments and modifications above may be realized by storing a program, in which the procedure of the method is described, in a memory in advance, and causing the CPU (Central Processing Unit) or the like to read the program from the memory and execute it.

Furthermore, a program describing the procedure of the method may be recorded on a recording medium and distributed in that form. Recording mediums on which the program is recorded include an IC card, a hard disk, an optical disc, a flexible disc, a ROM, and a flash memory.

(14) The present invention may be any combination of the above-described embodiments and modifications.

### 8. Supplementary Explanation

As described above, by adding description of information, which identifies a sub stream that is transmitted on a transmission path (TS) different from the transmission path of the main stream, into the access information for the access to the main stream, it becomes possible for the receiving playback device to recognize the presence of the sub stream, obtain and record or play back the sub stream in synchronization with the main stream.

The following explains the structure, modifications and effects of a transmission device and a receiving playback device in one embodiment of the present invention.

(1) According to one aspect of the present invention, there is provided a transmission device comprising: a holder holding stream identification information associated with a first transmission stream among a plurality of transmission streams containing a plurality of types of information that are to be played back simultaneously by a receiving playback device, the stream identification information identifying, among the plurality of transmission streams, at least one transmission stream that is different from the first transmission stream; and a transmitter configured to transmit the stream identification information.

With the above-described structure, the transmission device transmits the stream identification information. Accordingly, even when various types of information are transmitted in a plurality of transmission streams, the receiving side can identify a transmission stream that is to be played back simultaneously with the first transmission stream, by using the stream identification information. Note that the stream identification information corresponds to any of the new descriptors and new elements explained in the embodiments and modifications above: “external_ES_descriptor( )”, “service_subset_ES_descriptor( )”, “external_ES_link_info”, “subset_service_ES_info”, “hyper_link_descriptor( )”, “link_external_component_info( )”, “object”, and “ExternalES”.

In the above-described transmission device, the first transmission stream may conform to an MPEG2-TS (Transport Stream) format and is made to correspond to a PMT (Program Map Table), and the transmitter may multiplex and transmit the first transmission stream and the PMT in which the stream identification information is described.

With the above-described structure, the transmission device multiplexes and transmits the first transmission stream and the PMT in which the stream identification information is described. This makes it possible for the receiving side to identify a transmission stream that is to be played back simultaneously with the first transmission stream, by using the PMT before decoding the first transmission stream.

(3) In the above-described transmission device, the stream identification information may further contain synchronization information that is used to synchronize the plurality of transmission streams during simultaneous playback thereof.

With the above-described structure, the transmission device transmits the stream identification information containing the synchronization information. This makes it possible for the receiving side to play back the plurality of transmission streams simultaneously by synchronizing them based on the synchronization information.

(4) In the above-described transmission device, the stream identification information may specify, as a standard of the synchronization, one of PCRs (Program_Clock_References) that are respectively included in the plurality of transmission streams.

With the above-described structure, the transmission device transmits the synchronization information that specifies one of PCRs respectively included in the plurality of transmission streams. This makes it possible for the receiving side to play back the transmission streams based on the specified PCR, namely, the playback timing of the transmission stream including the specified PCR.

(5) In the above-described transmission device, the synchronization information may indicate that the plurality of transmission streams use a same time stamp.

With the above-described structure, the transmission device transmits the synchronization information which indicates that the plurality of transmission streams use a same time stamp. This makes it possible for the receiving side to play back the transmission streams based on the time stamp.

(6) In the above-described transmission device, the PMT may include playback information that indicates whether or not the first transmission stream can be played back independently.

With the above-described structure, the transmission device transmits the playback information. This makes it possible for the receiving side to play back the first transmission stream without playing back another transmission stream when the playback information indicates that the first transmission stream can be played back independently.

(7) In the above-described transmission device, the first transmission stream may conform to an MPEG2-TS (Transport Stream) format and is made to correspond to SI/PSI (Service Information/Program Specific Information), and the transmitter multiplexes and transmits the first transmission stream and the SI/PSI in which the stream identification information is described.

With the above-described structure, the transmission device multiplexes and transmits the first transmission stream and the SI/PSI in which the stream identification information is described. This makes it possible for the receiving side to identify a transmission stream that is to be played back simultaneously with the first transmission stream, by using the SI/PSI before decoding the first transmission stream.

(8) In the above-described transmission device, the first transmission stream may be distributed in an IP (Internet Protocol) network and is made to correspond to a playback control metafile, and the transmitter may transmit the playback control metafile that includes the stream identification information, separately from the first transmission stream.

With the above-described structure, the transmission device transmits the playback control metafile that includes the stream identification information, separately from the first transmission stream. This makes it possible for the receiving side to identify a transmission stream that is to be played back simultaneously with the first transmission stream, by using the playback control metafile before decoding the first transmission stream.

(9) In the above-described transmission device, the first transmission stream may conform to an MPEG2-TS (Transport Stream) format and is made to correspond to a data broadcast content descriptor, and the transmitter may multiplex and transmit the first transmission stream and the data broadcast content descriptor in which the stream identification information is described.

With the above-described structure, the transmission device multiplexes and transmits the first transmission stream and the data broadcast content descriptor in which the stream identification information is described. This makes it possible for the receiving side to identify a transmission stream that is to be played back simultaneously with the first transmission stream, by using the data broadcast content before decoding the first transmission stream.

(10) In the above-described transmission device, the first transmission stream may be transmitted in a server-type broadcast and is made to correspond to metadata, and the transmitter transmits the metadata containing program element information in which the stream identification information is described.

With the above-described structure, the transmission device transmits the metadata containing program element information in which the stream identification information is described. This makes it possible for the receiving side to identify a transmission stream that is to be played back simultaneously with the first transmission stream, by using the metadata before decoding the first transmission stream.

(11) According to another aspect of the present invention, there is provided a receiving playback device for receiving and playing back a program, the receiving playback device comprising: a first receiver configured to receive a first transmission stream and transmission information, the first transmission stream constituting the program, the transmission information indicating whether or not a second transmission stream, which is to be played back simultaneously with the first transmission stream, is transmitted; a judging unit configured to judge whether or not the second transmission stream is transmitted, based on the transmission information; a second receiver configured to receive the second transmission stream when the judging unit judges that the second transmission stream is transmitted; and a playback unit configured to play back both the first transmission stream and the second transmission stream when the judging unit judges that the second transmission stream is transmitted, and play back both the first transmission stream when the judging unit judges that the second transmission stream is not transmitted.

With the above-described structure, the receiving playback device can judge, by using the transmission information, whether or not a second transmission stream, which is to be played back simultaneously with the first transmission stream, is present. This makes it possible for the receiving playback device to play back both the first transmission stream and the second transmission stream when it judges that the second transmission stream is present. With this structure, the viewer can receive various service. Note that the transmission information corresponds to any of the PMT, EIT, and playback control file explained in the embodiments and modifications above.

(12) In the above-described receiving playback device, the first transmission stream may conform to an MPEG2-TS (Transport Stream) format, and the first receiver receives the transmission information described in a PMT (Program Map Table) multiplexed with the first transmission stream.

With the above-described structure, the receiving playback device can judge whether or not a second transmission stream, which is to be played back simultaneously with the first transmission stream, is present by using the PMT before decoding the first transmission stream.

(13) In the above-described receiving playback device, the transmission information further contains synchronization information that is used to synchronize the first transmission stream and the second transmission stream during simultaneous playback thereof, and the playback unit performs a synchronous playback of the first transmission stream and the second transmission stream based on the synchronization information.

With the above-described structure, the receiving playback device can perform a synchronous playback of the first transmission stream and the second transmission stream based on the synchronization information.

(14) In the above-described receiving playback device, the playback unit may perform the synchronous playback by using a PCR (Program_Clock_References) that is indicated by the synchronization information and is one of a PCR included in the first transmission stream and a PCR included in the second transmission stream.

With the above-described structure, the receiving playback device can play back the first and second transmission streams simultaneously by synchronizing them based on the playback timing of the PCR indicated by the synchronization information.

(15) In the above-described receiving playback device, the playback unit may perform the synchronous playback by using a time stamp that is indicated by the synchronization information.

With the above-described structure, the receiving playback device can play back the first and second transmission streams simultaneously by synchronizing them based on the time stamp.

(16) In the above-described receiving playback device, the first transmission stream may conform to an MPEG2-TS (Transport Stream) format, and the first receiver receives the transmission information described in SI/PSI (Service Information/Program Specific Information) multiplexed with the first transmission stream.

With the above-described structure, the receiving playback device can identify the second transmission stream by using the SI/PSI before receiving it.

(17) In the above-described receiving playback device, the first transmission stream may be distributed in an IP (Internet Protocol) network, and before receiving the first transmission stream, the first receiver receives the transmission information included in a playback control metafile that corresponds to the first transmission stream.

With the above-described structure, the receiving playback device can identify the second transmission stream by using the playback control metafile before receiving the first transmission stream.

(18) In the above-described receiving playback device, among the plurality of transmission streams, at least one transmission stream may conform to an MPEG2-TS (Transport Stream) format, and the first receiver receives the transmission information described in a data broadcast content descriptor multiplexed with the first transmission stream.

With the above-described structure, the receiving playback device can identify the second transmission stream by using the data broadcast content when playing back the first transmission stream.

(19) In the above-described receiving playback device, the first transmission stream may be transmitted in a server-type broadcast, and the first receiver may receive the transmission information described in a program element information contained in metadata that corresponds to the first transmission stream.

With the above-described structure, the receiving playback device can identify the second transmission stream by using the metadata.

(20) In the above-described receiving playback device, when the second receiver receives, before the judging unit judges whether or not the second transmission stream is transmitted, the second transmission stream and playback information that indicates whether or not the second transmission stream can be played back independently, the judging unit may further judge whether or not the second transmission stream can be played back independently, based on the playback information, and when the judging unit judges that the second transmission stream can be played back independently, the playback unit may play back the second transmission stream.

With the above-described structure, when the playback information indicates that the second transmission stream can be played back independently, the receiving playback device plays back the second transmission stream without playing back the first transmission stream simultaneously.

### INDUSTRIAL APPLICABILITY

The present invention is applicable to a device that transmits various types of information such as caption data and video of different viewpoints as well as video of a program, and a device that receives and plays back the video of the program and various types of information.

### REFERENCE SIGNS LIST

10 program distribution system
100, 200, 1100, 1200 transmission device
101 left-eye video encoder
102 audio encoder
103 left-eye video stream storage
104 audio stream storage
105, 205 information holder
106, 206, 1106, 1206 multiplexer
107, 207, 1107, 1207 transmitter
201 right-eye video encoder
203 right-eye video stream storage
300, 1300 digital TV (receiving playback device)
301, 1301 controller
302, 1302 reception processing unit
303 playback processing unit
304 output unit
310, 1310 first receiver
311, 1311 second receiver
320 first demultiplexer
321 second demultiplexer
322 sync controller
323 first video decoder
324 second video decoder
325 audio decoder
326 video processing unit
1105, 1205 file holder
1305 transmitter

1-22. (canceled)

23. A transmission device comprising:
a holder holding stream identification information and synchronization track reference information, the stream identification information being associated with a main stream, which is one of a plurality of transmission streams containing a plurality of types of information that are to be played back simultaneously by a receiving playback device, and identifying a sub stream that is another one of the plurality of transmission streams, the synchronization track reference information being used to synchronize the main stream and the sub stream when the receiving playback device plays back the main stream and the sub stream simultaneously; and
a transmitter configured to transmit the stream identification information and the synchronization track reference information.

24. The transmission device of claim 23, wherein
the stream identification information is URL (Uniform Resource Locator) information that is used to access the sub stream.

25. The transmission device of claim 24, wherein
the main stream conforms to an MPEG2-TS (Transport Stream) format and is made to correspond to MPEG2 Private Section, and
the transmitter multiplexes and transmits the main stream and the MPEG2 Private Section in which the stream identification information is described.

26. The transmission device of claim 25, wherein
the MPEG2 Private Section is PSI (Program Specific Information).

27. The transmission device of claim 25, wherein
the MPEG2 Private Section is PMT (Program Map Table).

28. The transmission device of claim 25, wherein
the MPEG2 Private Section is ATSC (Advanced Television Systems Committee) PSIP (Program and System Information Protocol).

29. The transmission device of claim 25, wherein
the MPEG2 Private Section is SI (Service Information).

30. A receiving playback device for receiving and playing back a program, the receiving playback device comprising:
a first receiver configured to receive a first transmission stream and transmission information, the first transmission stream constituting the program, the transmission information indicating whether or not a second transmission stream, which is to be played back simultaneously with the first transmission stream, is transmitted;
a judging unit configured to judge whether or not the second transmission stream is transmitted, based on the transmission information;
a second receiver configured to receive the second transmission stream when the judging unit judges that the second transmission stream is transmitted; and
a playback unit configured to play back both the first transmission stream and the second transmission stream when the judging unit judges that the second transmission stream is transmitted, and play back both the first transmission stream when the judging unit judges that the second transmission stream is not transmitted, wherein
the transmission information contains synchronization track reference information that is used to synchronize the first transmission stream and the second transmission stream when the first transmission stream and the second transmission stream are played back simultaneously, and
the playback unit performs a synchronous playback of the first transmission stream and the second transmission stream by using the synchronization track reference information.

31. A transmission method for use in a transmission device having a holder holding stream identification information and synchronization track reference information, the stream identification information being associated with a main stream, which is one of a plurality of transmission streams containing a plurality of types of information that are to be played back simultaneously by a receiving playback device, and identifying a sub stream that is another one of the plurality of transmission streams, the synchronization track reference information being used to synchronize the main stream and the sub stream when the receiving playback device plays back the main stream and the sub stream simultaneously, the transmission method comprising:
transmitting the stream identification information and the synchronization track reference information.

32. A receiving playback method for use in a receiving playback device for receiving and playing back a program, the receiving playback method comprising:
receiving a first transmission stream and transmission information, the first transmission stream constituting the program, the transmission information indicating whether or not a second transmission stream, which is to be played back simultaneously with the first transmission stream, is transmitted;
judging whether or not the second transmission stream is transmitted, based on the transmission information;
receiving the second transmission stream when the judging step judges that the second transmission stream is transmitted; and
playing back both the first transmission stream and the second transmission stream when the judging step judges that the second transmission stream is transmitted, and playing back the first transmission stream when the judging step judges that the second transmission stream is not transmitted, wherein
the transmission information contains synchronization track reference information that is used to synchronize the first transmission stream and the second transmission stream when the first transmission stream and the second transmission stream are played back simultaneously, and
the playing back performs a synchronous playback of the first transmission stream and the second transmission stream by using the synchronization track reference information.
